(19) United States
(12) Patent Application Publication
(10) Pub. No.: US 2009/0029121 A1
(43) Pub. Date: Jan. 29, 2009

(54) NANOPARTICULATE METAL BORIDE COMPOSITION AND ITS USE FOR IDENTIFICATION-MARKING PLASTIC PARTS

(75) Inventors: Markus Hammermann, Dossenheim (DE); Gero Nordmann, Heidelberg (DE); Ralf Neuhaus, Heidelberg (DE); Nobert Wagner, Mutterstadt (DE); Claudia Sierakowski, Seeheim-Jugenheim (DE); Arno Bohn, Mannheim (DE); Frank Prissok, Lemforde (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFEN (DE)

(21) Appl. No.: 12/282,578

(22) PCT Filed: Feb. 6, 2007
(86) PCT No.: PCT/EP2007/051135

§ 371 Date: Sep. 11, 2008

(30) Foreign Application Priority Data
Mar. 20, 2006 (EP) 06005658.7

(51) Int. Cl. B32B 5/00; B29C 45/00; B29C 47/00; B29C 49/00; B29C 53/00; B23K 26/00; C09K 3/00; B32B 37/00; C08K 3/38; C09D 11/02

(52) U.S. Cl. 428/195.1; 264/109; 156/60; 252/182.32; 252/182.12; 252/182.28; 252/182.24; 524/404; 106/31.13; 219/121.69

(57) ABSTRACT

The present invention relates to a process for the identification-marking of plastics parts.

The present invention relates to a nanoparticulate alkaline earth metal boride composition or nanoparticulate rare earth metal boride composition, a polymer composition, and a printing ink composition which comprises this nanoparticulate composition, a process for identification-marking (marking) plastics parts, and also the further use of this nanoparticulate composition.

Preparations of particles whose sizes are in the nanometer range (nanoscale particles) are used in many industrial sectors.

EP-A-1529632 describes a multilayer item, e.g. in the form of foil providing protection from heat, comprising a core layer and at least one first outer layer. The core layer comprises a thermoplastic polymer and an IR absorber. The first outer layer comprises a thermoplastic polymer and an additive which is capable of absorbing electromagnetic radiation. Nanoparticulate metal borides can be used as IR-absorbing additives. This IR-absorber layer is produced starting from a masterbatch which comprises the metal boride in a solid polymeric carrier, for example by extrusion or coextrusion.

US-A-2004/0028920 describes a masterbatch composition which comprises a thermoplastic polymer and a metal hexaboride as component providing shielding from radiated heat.

U.S. Pat. No. 6,663,950 describes an optically active composite in the form of a film and comprising a coating based on a polymeric binder which comprises nanoparticulate antimony tin oxide and nanoparticulate lanthanum hexaboride. Production of the coating uses a 2.2% strength by weight nanoparticulate preparation of lanthanum hexaboride in toluene, i.e. a low-boiling-point solvent.

U.S. Pat. No. 6,911,254 describes glass laminates with polymeric intermediate layers comprising LaB₆ nanoparticles and, if appropriate, also doped tin oxide nanoparticles, and also comprising colorants and further additives. The LaB₆ here is either dispersed in the intermediate-layer polymer or is applied thereto in a further layer. For this, a LaB₆ preparation as described in U.S. Pat. No. 6,663,950 is used, or a 6.3% strength by weight LaB₆ preparation in triethylene glycol bis(2-ethyl)hexanoate.

The disclosure of WO 2005/059013 is comparable to that of U.S. Pat. No. 6,663,950 and of U.S. Pat. No. 6,911,254.

U.S. Pat. No. 6,737,159 describes a polyvinyl butyral foil which comprises at least one NIR absorber of quaterylene type and also, if appropriate, an inorganic IR absorber, such as LaB₆.

U.S. Pat. No. 6,620,872 describes a polyvinyl butyral composition which comprises dispersed lanthanum hexaboride nanoparticles, if appropriate in a mixture with doped tin oxides. The production process uses a 2.2% strength by weight preparation of lanthanum hexaboride nanoparticles in toluene or in triethylene glycol bis(2-ethyl)hexanoate.

EP-A-1008564 describes liquid compositions for producing heat-shielding films, which comprise nanoparticulate metal hexaboride particles in combination with nanoparticulate tin-containing indium oxides (ITO) or with antimony-containing tin oxides (ATO). Suitable solvents stated are very generally water and organic solvents, such as alcohols, ethers, esters, or ketones, and specifically isobutyl alcohol and 4-hydroxy-4-methylpentan-2-one are used.

EP-A-0905100 describes a coating dispersion for forming a selectively permeable film, where the coating comprises nanoparticles, inter alia lanthanum boride.

EP-A-943587 describes a liquid coating composition for forming a film to provide shielding from radiated heat, where the film comprises nanoparticulate metal borides.

US-A-2005/0161642 describes nanoparticulate metal hexaborides surface-modified with silicones and dispersions of these hexaborides in a liquid or solid medium.

The identification-marking of products is of increasing importance in almost every branch of industry. For example, production data, expiry dates, bar codes, company logos, serial numbers, etc. often have to be applied to such products. Conventional techniques, such as printing, embossing, stamping and labeling are often still used for such markings. However, an increasingly important method uses lasers for contactless, very rapid and flexible marking, in particular for plastics products and plastics packaging. This technique permits application of identification marks such as graphics, e.g. bar codes, at high speed even on a non-planar surface. Since the inscription is located within the plastics article itself, it is durable, abrasion-resistant, and counterfeiting-resistant.

Alongside CO₂ lasers, Nd-YAG lasers and excimer lasers are increasingly used for laser identification-marking of plastics. However, laser-marking of some plastics, e.g. polyolefins and polystyrenes, is difficult or impossible without additional modification. For example, a CO₂ laser emitting light in the infrared region at 10.6 μm gives only a weak, barely legible marking on polyolefins and polystyrenes even at very high power levels. In the case of polyurethanes and polyetheresters, when Nd-YAG lasers are used there is likewise no interaction. In order to achieve good marking, there must be neither complete reflection nor complete transmission of the laser light by the plastic, since there is then no interaction. In contrast, if there is too much energy absorption, the plastic can vaporize in the irradiated region, the result then being engraving rather than visible graphic identification-marking.

It is known that plastics can be rendered laser-inscribable by adding appropriate absorbers to them, examples being absorbent pigment particles. The incident laser light is then converted into heat, thus markedly increasing the temperature of the pigment particles within fractions of a second. If, in a highly localized region of the plastic, more heat is generated by absorbed light than can be simultaneously dissipated to the environment, the result is marked local heating and either carbonization of the plastic or a chemical reaction of the plastic and/or of the absorber, or formation of a gas, e.g. of CO₂. These processes lead to a color change and thus to marking of the plastic.

It is known that organic dyes and pigments can be used for modification of plastics in order to render them laser-markable.

EP-A-684144 describes a composition for the coloring of plastics parts via laser irradiation, which comprises a mixture composed of at least one opacifier and of at least one chromogenic compound. The opacifiers here have been selected from mica, nanoscale TiO₂, and metal oxides based on antimony oxide.

WO 01/00719 describes a polymer composition which comprises a polymer and an additive, permitting laser-marking. To this end, antimony trioxide is used with particle size >0.5 μm at a concentration of at least 0.1% by weight.

WO 95/30546 describes laser-markable plastics, in particular thermoplastic polyurethanes, which comprise pigments which have been coated with doped tin dioxide.

WO 02/055287 describes a process for production of laser-welded composite moldings.

WO 2005/102672 describes a process for the welding of plastics parts with the aid of laser radiation, in which one of the plastics parts to be bonded has, in the bonding region, a material which absorbs the laser radiation, and where, inter alia, a lanthanoid hexaboride or alkaline earth metal hexaboride can be involved. For provision of the additive, the hexaboride is used in the form of 1% strength by weight masterbatch in polymethyl methacrylate.

DE-A-102004051457 describes laser-weldable plastics materials colored via colorants and comprising nanoscale laser-sensitive particles, such as lanthanum hexaboride. For preparation of these colorants, the nanoscale particles are incorporated with high shear into the plastics matrix or into a liquid monomer-containing starting composition.

DE-A-10 2004 0105 04 describes highly transparent plastics materials which by virtue of their content of nanoscale laser-sensitive metal oxides are laser-markable and/or laser-weldable. The preparation method is analogous to the process described in DE-A-10 2004 051 457. The disclosure of DE-U-20 2004 003 362 is comparable with that of DE 10 2004 010 504.

The abovementioned processes have at least one of the following disadvantages:
Pigments are used whose particle sizes are in the μm range (>1000 nm) and which therefore exhibit considerable scattering in the visible region of the spectrum. It is therefore not possible to inscribe transparent plastics.
At the laser wavelength used for the identification-marking process, the absorption of the doping substance is not maximal. The result is a requirement to use a larger amount of the doping substance, often more than 0.1%.
It is undesirable to use doping substances comprising antimony, because the doped plastics are subjected to undesirable heavy-metal pollution.
Some of the pigments used hitherto as doping substance, e.g. antimony-doped tin oxide, can conduct electricity. Their use increases the conductivity of the plastic comprising additive and thus lowers its tracking resistance, a disadvantageous effect for certain applications.

WO 2006/029677, published after the priority date of the present application, describes laser-markable and/or laser-weldable polymers which comprise, as absorber, at least one boride compound, lanthanum hexaboride being an example of a compound involved here. Individual inventive examples include very fine grinding of lanthanum hexaboride in weakly acidic aqueous suspension. However, in every case the liquid carrier medium is removed prior to incorporation into the polymer. These LaB₆ preparations do not involve fully dispersed preparations for the purposes of the present invention.

There is moreover a large requirement for nanoparticulate preparations of metal borides with high solids contents, preferably suitable for providing additives to high-molecular-weight organic and inorganic materials, in particular polymers and printing inks. In one specific embodiment, the nanoparticulate preparations are intended to be suitable for use in a process for identification-marking plastics which avoids as many as possible of the abovementioned disadvantages.

The invention therefore firstly provides a fully dispersed, nanoparticulate preparation, comprising a carrier medium which is liquid under standard conditions and at least one particulate phase of nanoscale particles dispersed therein, comprising at least one metal boride of the general formula MB₆, in which M is a metal component.

The invention further provides a polymer composition which comprises at least one such nanoparticulate preparation.

The invention further provides a printing ink composition which comprises at least one such nanoparticulate preparation.

The invention further provides a process for the modification of a plastics part with at least one metal boride, by
providing a fully dispersed, nanoparticulate preparation of dispersed nanoscale particles of at least one metal boride of the general formula MB₆, in which M is a metal component, in a carrier medium which is liquid under standard conditions, by comminuting the metal boride in the carrier medium, and
incorporating the fully dispersed, nanoparticulate preparation into the plastics part or applying it to the plastics part, or using it for production of the plastic for the plastics part.

The invention further provides a process for the identification-marking of a plastics part, in which
a plastics part is provided which has, at least in the region to be identification-marked, at least one nanoparticulate metal boride of the general formula MB₆ which absorbs laser radiation, where M is a metal component, and
the plastics part is irradiated with laser radiation for the identification-marking process.

According to the invention, the plastics parts comprise the metal boride in nanoparticulate form (in the form of nanoscale particles). It is preferable that in the inventive process for identification-marking a plastics part, a plastics part is provided which comprises a fully dispersed, nanoparticulate preparation, as defined above.

For the purposes of the invention, a “fully dispersed” preparation is a preparation in which the dispersed nanoscale particles present comprise substantially no associations of molecules in the form of aggregates. Aggregates here are associations with strong van der Waals interactions, generally then being incapable of redispersion (e.g. via introduction of energy by means of shear forces). Substantially no associations of molecules in the form of aggregates means that, in the fully dispersed preparation, at most 1% by weight, preferably at most 0.1% by weight, of the nanoscale particles, based on the total content of nanoscale particles, are present in the form of aggregates. For the purposes of the invention, a “fully dispersed” preparation comprises moreover only a small proportion of substantially no associations of molecules in the form of agglomerates. Agglomerates here are associations which can be redispersed to give nanoscale particles. The proportion of nanoscale particles in the form of agglomerates in the fully dispersed preparation is preferably at most 10% by weight, preferably at most 1% by weight, based on the total content of nanoscale particles. For the purposes of the invention, a “fully dispersed” preparation can comprise associations of molecules in the form of flocculates. Flocculates are particularly loose agglomerates as produced, for example, by gravitational sedimentation, being generally completely surrounded by the carrier medium, and can be redispersed simply by stirring.

For the purposes of the present application “nanoscale particles” are particles whose volume-average particle diameter is generally at most 200 nm, preferably at most 100 nm. A preferred particle size range is from 4 to 100 nm, in particular from 5 to 90 nm. Particles of this type generally feature high uniformity in relation to their size, size distribution, and morphology. The particle size here can be determined by the UPA (ultrafine particle analyzer) method, for example, e.g. by the laserlight backscattering method.

For the purposes of the present invention, a “nanoparticulate preparation” is a preparation which comprises nanoscale particles, and this means that there is no, or only a subordinatic extent of, reagglomeration or accretion of the nanoscale particles. The inventive nanoparticulate preparations can advantageously be dispersed very substantially in the form of primary particles, thus forming extremely stable dispersions. The inventive “nanoparticulate preparation” is therefore a “fully dispersed preparation”. For the purposes of the present invention, the expression “standard conditions” means a standard temperature of 25° C.=298.15 K and a standard pressure of 101 325 Pa.

For the purposes of the present invention, the expression “liquid” indicates rheological properties which extend from low-viscosity liquid properties by way of pasty/unctuous properties and on as far as gel-like properties. “Flowable compounds” generally have higher viscosity than a liquid but are nevertheless not self-supporting, i.e. they do not, without encapsulation to stabilize shape, retain a shape imposed upon them. For the purposes of the present invention, the expression “liquid” is also intended to comprise flowable components. The viscosity of these preparations is by way of example in the range from about 1 to 60000 mPas.

The metal boride MB₆ has preferably been selected from alkaline earth metal borides, rare earth metal borides, and mixtures thereof. Particular metal hexaborides MB₆ which may be mentioned are yttrium, lanthanum, cerium, praseodymium, neodymium, samarium, europium, gadolinium, terbium, dysprosium, holmium, erbium, thulium, ytterbium, strontium, or calcium hexaboride. A preferred metal boride MB₆ is lanthanum hexaboride.

The nanoparticulate preparations according to the invention are transparent in the visible region of the electromagnetic spectrum and are in essence colorless. An advantageous result of this is that there will be only very little, or no, discernible change in the appearance to the naked eye of compositions, especially plastics compositions, which comprise a nanoparticulate metal boride of this type. Furthermore, the considerable scattering observed in the case of microdisperse additives in the visible region of the spectrum is avoided, thus also permitting very good inscription of transparent plastics with the compositions according to the invention and by the inventive process for identification-marking plastics parts. In contrast, the nanoparticulate metal borides used according to the invention have marked absorption in the IR region (from about 700 to 12000 nm), preferably in the NIR region of from 700 to 1500 nm, particularly preferably in the region from 900 to 1200. The inventive fully dispersed nanoparticulate preparations are therefore advantageously suitable for providing additives to high-molecular-weight organic and inorganic compositions, in particular of plastics, of lacquers and of printing inks, for use in organic and inorganic composites, and in oxidic layer systems. They are particularly suitable as additive for the laser-welding of plastics, and also during plastics processing involving heating. When the process of plastics involves heating, radiation sources (e.g. thermal lamps) are often used. These generally feature a broad emission spectrum, e.g. in the range from about 500 to 1500 nm. However, many plastics have inadequate absorption of radiation in this wavelength range, and the result is high energy losses. This applies specifically to polyesters, in particular polyethylene terephthalates as used for production of bottles by blow molding, for example. The inventive nanoparticulate preparations are specifically suitable as “reheat” additives for these plastics. The inventive nanoparticulate preparations are also suitable as component of compositions for electrophotography, as component of compositions for security printing, and as component of compositions for control of energy-transfer properties. Among these are compositions such as those used in what is known as solar energy management, examples being plastics glazing that provides protection from heat, foils that provide protection from heat (e.g. for agricultural applications, an example being greenhouses), coatings that provide protection from heat, etc. The inventive fully dispersed nanoparticulate preparations are also suitable with particular advantage for providing additives to plastics intended to undergo laser-marking (e.g. using an Nd-YAG laser at 1064 nm).

Furthermore, the thermal stability of the fully dispersed nanoparticulate preparations according to the invention generally extends to at least 300° C., and they can therefore also be incorporated directly, without decomposition, into a polymer composition by the familiar, low-cost processes for incorporating additives into compositions, thus simplifying the process. Since they are advantageously neither degraded via thermal stress nor degraded via irradiation, they permit precise adjustment of the polymer composition to a desired shade, which is not changed even via the subsequent identification-marking process, except in the identification-marked region. The stability of the nanoparticulate metal borides used according to the invention also permits their use for applications in which production of undefined degradation products has to be excluded, examples being applications in the medical sector and in the food-packing sector.

Finally, the inventive nanoparticulate metal borides are very substantially resistant to migration in all of the familiar matrix polymers, this likewise being a fundamental precondition for use in the medical sector and in the food-packing sector.

Processes for the preparation of nanoscale particles are known in principle. By way of example, they are based on the precipitation from aqueous solutions of metal salts via raising or lowering of the pH, using a suitable base or acid. For production of the inventive preparations, by way of example, at least one metal boride MB₆ which by this stage takes the form of nanoscale particles can be brought into intimate contact with the carrier medium. The materials are preferably brought into contact here with introduction of shear energy in apparatuses known for this purpose. Among these are, for example, stirred tanks, ultrasound homogenizers, high-pressure homogenizers, dynamic mixers, such as toothed-wheel dispersers and Ultra-Turrax devices, and also static mixers, e.g. systems with mixing nozzles.

The inventive nanoparticulate preparation is preferably prepared via incorporation of at least one metal boride MB₆ into the carrier medium with simultaneous comminution, preferably with milling. In this variant, too, it is, of course, possible to use a metal boride MB₆ which by this stage takes the form of nanoscale particles.

The comminution process takes place in devices suitable for this purpose, preferably in mills, such as ball mills, stirred ball mills, circulation mills (stirred ball mills with grinding system comprising pins), disk attrition mills, annular chamber mills, double-cone mills, three-roll mills, and batch mills. If desired, the grinding chambers are equipped with cooling apparatuses for dissipation of the heat introduced during the grinding process. Examples of machines for wet grinding to prepare the inventive preparations are the Drais Superflow DCP SF 12 ball mill, the ZETA circulation mill system from Netzsch-Feinmahltechnik GmbH or the disk attrition mill from Netzsch Feinmahltechnik GmbH, Selb, Germany.

The comminution process preferably takes place with addition of the principal amount of the carrier medium, in particular at least from 80% to 100%.

The period required for the comminution process depends in a manner known per se on the desired degree of fineness or on the particle size of the active-ingredient particles, and can be determined in routine experiments by the person skilled in the art. Examples of grinding periods which have proven successful are those in the range from half an hour to 72 hours, but a longer period is also conceivable.

Pressure conditions and temperature conditions during the comminution process are generally non-critical, and by way of example atmospheric pressure has proven suitable. Temperatures in the range from 10° C. to 100° C. have, by way of example, proven suitable.

The particles used can be surface-modified or surface-coated in order substantially to prevent agglomeration or concretion of the nanoscale particles and/or in order to ensure good dispersibility of the particulate phase in the coherent phase of the inventive preparations. By way of example, at least one part of the surface of the particles has a single- or multilayer coating which comprises at least one compound having ionogenic, ionic, and/or nonionic surface-active groups. The compounds having surface-active groups have preferably been selected from the salts of strong inorganic acids, e.g. nitrates and perchlorates, saturated and unsaturated fatty acids, such as palmitic acid, margaric acid, stearic acid, isostearic acid, nonadecanoic acid, lignoceric acid, palmitoleic acid, oleic acid, linoleic acid, linolenic acid, and eleostearic acid, quaternary ammonium compounds, such as tetraalkylammonium hydroxides, e.g. tetramethylammonium hydroxide, silanes, such as alkyltrialkoxysilanes and mixtures of these. In a preferred embodiment, the nanoscale particles used according to the invention have no surface modifiers.

The fully dispersed, nanoparticulate preparation is preferably produced by in-situ comminution, specifically in-situ milling, in the liquid carrier medium in which it is subsequently used (e.g. via incorporation into or application to a polymer composition). In particular, once the fully dispersed condition has been reached here, the carrier medium is then not removed from the nanoparticulate preparation, its proportion being reduced by no more than the extent that permits retention of the fully dispersed condition. Any partial or complete replacement of the carrier medium takes place via liquid-liquid conversion in which the fully dispersed condition is retained. It is preferable that, after production of the fully dispersed, nanoparticulate preparation, the carrier medium is not then replaced. However, it is possible to add at least one further component compatible with the carrier medium, as long as the fully dispersed condition is retained in this process. One or more further components can be added prior to, during, or after the production of the fully dispersed preparation. It is preferable that the preparation obtained via in-situ comminution is subjected to further processing immediately after its production.

The solids content of the inventive nanoscale preparation is preferably at least 10% by weight, particularly preferably at least 20% by weight, based on the total weight of the preparation.

The content of metal boride MB₆ in the inventive nanoscale preparation is preferably at least 50% by weight, particularly preferably at least 70% by weight, based on the total solids content of the preparation.

The carrier medium (the coherent phase) of the inventive nano-particulate preparations is liquid under standard conditions. The boiling point of the carrier medium (or of the carrier medium mixture) is preferably at least 40° C., particularly preferably at least 65° C.

The carrier medium is preferably selected from esters of alkyl and aryl carboxylic acids, hydrogenated esters of aryl carboxylic acids, polyhydric alcohols, ether alcohols, polyether polyols, ethers, saturated acyclic and cyclic hydrocarbons, mineral oils, mineral oil derivatives, silicone oils, aprotic polar solvents, and mixtures thereof.

Where liquid esters of alkyl carboxylic acids are suitable as carrier medium they are preferably based on a C₁-C₂₀-alkane carboxylic acid. These have preferably been selected from formic acid, acetic acid, propionic acid, butyric acid, valeric acid, caproic acid, oenanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, and arachic acid. The esters are preferably based on the alkanols mentioned below, on polyhydric alcohols, on ether alcohols, and on polyether polyols.

Where liquid esters of aryl carboxylic acids are suitable as carrier medium they are preferably esters of phthalic acid with alkanols, in particular the esters with C₁-C₃₀ alkanols, specifically with C₁-C₂₀ alkanols, and very specifically with C₁-C₁₂ alkanols. Compounds of this type are commercially available, e.g. as plasticizers. Examples of alkanols are in particular methanol, ethanol, propanol, isopropanol, n-butanol, isobutanol, sec-butanol, tert-butanol, n-pentanol, 2-pentanol, 2-methylbutanol, 3-methylbutanol, 1,2-dimethylpropanol, 1,1-dimethylpropanol, 2,2-dimethylpropanol, 1-ethylpropanol, n-hexanol, 2-hexanol, 2-methylpentanol, 3-methylpentanol, 4-methyl-pentanol, 1,2-dimethylbutanol, 1,3-dimethylbutanol, 2,3-dimethylbutanol, 1,1-dimethyl-butanol, 2,2-dimethylbutanol, 3,3-dimethylbutanol, 1,1,2-trimethylpropanol, 1,2,2-tri-methylpropanol, 1-ethylbutanol, 2-ethylbutanol, 1-ethyl-2-methylpropanol, n-heptanol, 2-heptanol, 3-heptanol, 2-ethylpentanol, 1-propylbutanol, n-octanol, 2-ethylhexanol, 2-propylheptanol, 1,1,3,3-tetramethylbutanol, nonanol, decanol, n-undecanol, n-dodecanol, n-tridecanol, isotridecanol, n-tetradecanol, n-hexadecanol, n-octadecanol, n-eicosanol, and mixtures thereof.

Examples of polyhydric alcohols suitable as carrier medium are ethylene glycol, glycerol, 1,2-propanediol, 1,4-butanediol, etc. Examples of suitable ether alcohols are compounds having two terminal hydroxy groups connected via an alkylene group, which can have 1, 2 or 3 non-adjacent oxygen atoms. Among these are, for example, ethylene glycol monomethyl ether, ethylene glycol dimethyl ether, ethylene glycol diethyl ether, etc. Polyether polyols which are liquid under standard conditions are also suitable, examples being polyalkylene glycols. Among these are compounds having terminal hydroxy groups and having repeat units preferably selected from (CH₂CH₂O)ₓ₁, (CH(CH₃)CH₂O)ₓ₂, and ((CH₂)₄O))ₓ₃, where x1, x2 and x3 are, independently of one another, a whole number from 4 to 2500, preferably from 5 to 2000. The sum of x1, x2, and x3 is a whole number from 4 to 2500, in particular from 5 to 2000. In polyoxy-alkylene compounds which have two or three repeat units of different types, the sequence is as desired, i.e. the repeat units involved can have random distribution, can alternate, or can take the form of blocks. Preference is given to polyethylene glycol, polypropylene glycols, polyethylene glycol-co-propylene glycols and polytetrahydro-furans. Polytetrahydrofuran is preferred as carrier medium. Suitable ethers are acyclic and cyclic ethers, preferably cyclic ethers, particularly preferably tetrahydrofuran.

Examples of saturated acyclic and cyclic hydrocarbons suitable as carrier medium are tetradecane, hexadecane, octadecane, xylenes, and decahydronaphthalene.

Other compounds suitable as carrier medium are paraffin and paraffin oils, high-boiling-point mineral oil derivatives, such as decalin and white oil, and also liquid polyolefins.

Examples of aprotic polar solvents suitable as carrier medium are amides, such as formamide or dimethylformamide, dimethyl sulfoxide, acetonitrile, dimethyl sulfone, sulfolane, and also in particular nitrogen heterocycles, e.g. N-methylpyrrolidone, quinoline, quinaldine, etc.

In one specific embodiment, no water is used as carrier medium. However, it can be advantageous to use a carrier medium which comprises small amounts of water, generally at most 5% by weight, preferably at most 1% by weight, based on the total weight of the carrier medium. Clearly defined small amounts of water can contribute to stabilization of the inventive, fully dispersed, nanoparticulate preparation. This also applies when using carrier media which have only low miscibility with water.

In a further specific embodiment, the inventive fully dispersed, nanoparticulate preparation comprises a carrier medium which is suitable as component for production of a polymer. Among these are carrier media which are suitable as starting material (monomer) for a polymerization reaction. The polymerization reaction can involve a polycondensation, polyaddition, free-radical polymerization, cationic polymerization, anionic polymerization, or coordinative polymerization. It preferably involves a polycondensation or polyaddition. It is preferable that the carrier medium is used for the production of a polymer selected from polyethers, polyesters, polycarbonates, polyurethanes, and mixtures thereof. In one specific embodiment, the carrier medium is used for the production of a polyether selected from homopolymers and copolymers of cyclic ethers, such as the polyalkylene glycols defined below. In another specific embodiment, the carrier medium is used for the production of a polyether polyurethane, in particular based on at least one polytetrahydrofuran. In relation to the production process and to suitable and preferred components for the polyurethanes, reference is made to the statements below concerning said polymers.

It is preferable that the carrier medium used for production of a polymer has been selected from polyhydric alcohols, ether alcohols, polyether polyols, ethers, and mixtures thereof. It is particularly preferable that the carrier medium used for production of a polymer has been selected from ethylene glycol, glycerol, 1,3-propane-diol, 1,4-butanediol, ethylene glycol monomethyl ether, ethylene glycol dimethyl ether, ethylene glycol diethyl ether, acyclic and cyclic ethers, polyether polyols, and mixtures thereof. One specific carrier medium for production of a polymer is polytetrahydrofuran having terminal hydroxy groups. The molecular weight of the polytetrahydrofuran is preferably in the range from 200 to 10000, particularly preferably, 500 to 2500.

The carrier media used according to the invention can comprise at least one further component compatible with the carrier medium. Among these are, for example, natural and synthetic fats and waxes. Examples of suitable compounds are the esters of saturated and mono- or polyunsaturated, straight-chain or branched C₈-C₃₀ fatty acids with C₁-C₃₀ alkanols. Preference is given to the esters of saturated C₁₂-C₂₄ fatty acids with C₈-C₂₄ alkanols and to mixtures thereof. Among these, for example, is stearyl stearate.

The invention further provides a process for the modification of a plastics part with at least one metal boride, by
providing a fully dispersed, nanoparticulate preparation of dispersed nanoscale particles of at least one metal boride of the general formula MB₆, in which M is a metal component, in a carrier medium which is liquid under standard conditions, by comminuting the metal boride in the carrier medium, and
incorporating the fully dispersed, nanoparticulate preparation into the plastics part, or applying it to the plastics part, or using it for the production of plastic for the plastics part.

For production of polymer compositions, the inventive nanoparticulate preparations can be incorporated into a polymer component or applied by way of a lamination process or coating process to at least one part of such a composition. It is preferable to produce plastics compositions by a process of addition to a melt. Individual suitable processes that may be mentioned for addition to a melt are extrusion, and also coextrusion (where the thickness of the coextrusion layer to which additive is provided is generally at least 25 μm, typically 50 μm), injection molding, blow molding, and kneading.

The inventive nanoparticulate preparations are suitable, as mentioned, with particular advantage for use in polymer compositions and printing-ink compositions. The boiling point and/or the flashpoint of the nanoparticulate preparations are then preferably above the processing temperature used for production of the polymer composition or printing-ink composition.

The inventive nanoparticulate preparations are also suitable, as mentioned, with particular advantage for use in a process for identification-marking a plastics part. The plastics part used for identification-marking then preferably comprises an amount of at most 0.05% by weight, particularly preferably at most 0.02% by weight, based on the total weight of the plastics part, of the metal boride. The amounts required for use are therefore markedly smaller than in the case of other additives known in the prior art for laser-marking. The metal borides used according to the invention therefore avoid any undesired heavy-metal contamination of the doped plastics parts and moreover have good tracking resistance.

To carry out the inventive identification-marking process, it is sufficient that the nanoparticulate metal boride that absorbs laser radiation is present in that region of the plastics part that is to be identification-marked. However, it is often practicable to provide the metal boride additive in the entire plastics part, because the amounts required for use are small.

The carrier medium used according to the invention does not generally have to be removed after incorporation into a plastics part.

The invention further provides a polymer composition comprising at least one nanoparticulate preparation as defined above.

In one specific embodiment, the inventive polymer compositions, or the plastics parts used according to the invention, comprise a thermoplastic polymer component or are composed of a thermoplastic polymer component. Thermoplastics feature good processability and can be processed in the softened state to give moldings, e.g. via compression molding, extrusion, injection molding, or other shaping processes.

In another specific embodiment, the inventive polymer composition is obtainable via polymerization of a reaction mixture comprising a fully dispersed nanoparticulate preparation which comprises a liquid carrier medium which is at least to some extent incorporated into the polymer. Reference is made here to the entire content of the previous statements concerning these carrier media.

The inventive polymer compositions or the plastics parts used according to the invention comprise a polymer component, or are composed of a polymer component, which has preferably been selected from the group of the polyolefins, polyolefin copolymers, polytetrafluoroethylenes, ethylene-tetrafluoroethylene copolymers, polyvinyl chlorides, polyvinylidene chlorides, polyvinyl alcohols, polyvinyl esters, polyvinyl alkanals, polyvinyl ketals, polyamides, polyimides, polycarbonates, polycarbonate blends, polyesters, polyester blends, poly(meth)acrylates, poly(meth)acrylate/styrene copolymer blends, poly(meth)acrylate/polyvinylidene difluoride blends, polyurethanes, polystyrenes, styrene copolymers, polyethers, polyether ketones, polysulfones, and mixtures thereof.

Preference is given here to polymers from the group of the polyolefins, polyolefin copolymers, polyvinyl alkanals, polyamides, polycarbonates, polycarbonate/polyester blends, polycarbonate/styrene copolymer blends, polyesters, polyester blends, poly-(meth)acrylates, poly(meth)acrylate/styrene copolymer blends, poly(meth)-acrylate/polyvinylidene difluoride blends, styrene copolymers, and polysulfones and mixtures of these.

In another preferred embodiment, the inventive polymer composition comprises at least one polyurethane or is composed of at least one polyurethane. The polyurethane preferably involves at least one polyether polyurethane, particularly preferably at least one polytetrahydrofuran polyether urethane. Thermoplastic polyether polyurethanes are preferred.

Particularly preferred polymers for use as plastics parts for identification-marking are transparent or at least translucent. Examples which may be mentioned are: polypropylene, polyvinyl butyral, nylon-6, nylon-6,6, polycarbonate, polycarbonate/polyethylene terephthalate blends, polycarbonate/polybutylene terephthalate blends, polycarbonate/acrylonitrile-styrene-acrylonitrile copolymer blends, polycarbonate/acrylonitrile-butadiene-styrene copolymer blends, polymethyl methacrylate/acrylonitrile-butadiene-styrene copolymer blends (MABS), polyethylene terephthalate, polybutylene terephthalate, polymethyl methacrylate, impact-modified polymethyl methacrylate, polybutyl acrylate, polymethyl methacrylate/polyvinylidene difluoride blends, acrylonitrile-butadiene-styrene copolymers (ABS), styrene-acrylonitrile copolymers (SAN) and polyphenylene sulfone, and mixtures of these.

Suitable and preferred polymers are specified more precisely hereinafter.

A preferred embodiment of the present invention provides a polymer composition where the polymer has been selected from polyolefins, polyolefin copolymer, and polymer mixtures which comprise at least one polyolefin homo- or copolymer.

Preferred polyolefins comprise, incorporated into the polymer, at least one monomer selected from ethylene, propylene, 1-butene, isobutylene, 4-methyl-1-pentene, butadiene, isoprene, and mixtures thereof. Homopolymers are suitable, as also are copolymers of the olefin monomers mentioned, and copolymers composed of, as main monomer, at least one of the olefins mentioned, and of other monomers (e.g. vinylaromatics) as comonomers.

Examples of preferred polymers are those composed of olefins without additional functionality, e.g. polyethylene, polypropylene, 1-polybutene, or polyisobutylene, poly-4-methyl-1-pentene, polyisoprene, polybutadiene, polymers of cycloolefins, such as cyclopentene or norbornene, and copolymers of mono- or diolefins, an example being polyvinylcyclohexane.

Other preferred polyolefins are polyethylene homopolymers of low density (LDPE) and polypropylene homopolymers and polypropylene copolymers. Examples of preferred polypropylenes are biaxially oriented polypropylene (BOPP), and crystallized polypropylene. Preferred mixtures of the abovementioned polyolefins are mixtures of polypropylene with polyisobutylene, polypropylene with polyethylene (e.g. PP/HDPE, PP/LDPE), and mixtures of various types of polyethylene (e.g. LDPE/HDPE).

### Ethylene Polymers:

Examples of suitable polyethylene (PE) homopolymers, which are classified according to density, are:
ULDPE (ULD=ultralow density);
VLDPE (VLD=very low densitiy); approximate density below 0.905 g/cm³;
LDPE (LD=low density), obtainable by way of example by the high-pressure process (ICI) at from 1000 to 3000 bar and from 150 to 300° C., using oxygen or peroxides as catalysts in autoclaves or tubular reactors. Highly branched, with different branch lengths, crystallinity from 40 to 50%, density from 0.915 to 0.935 g/cm³, average molar mass up to 600000 g/mol;
LLDPE (LLD=linear low density), obtainable using metal complex catalysts in the low-pressure process from the gas phase, from a solution (e.g. petroleum sprit), in a suspension, or using a modified high-pressure process. Low level of branching, having no branching within side chains, molar masses higher than for LDPE.
MDPE (MD=medium density); density from 0.93 to 0.94 g/cm³;
HDPE (HD=high density), obtainable by the medium-pressure (Phillips) or low-pressure (Ziegler) process. In the case of the Phillips process at from 30 to 40 bar, from 85 to 180° C., chromium oxide as catalyst, molar masses about 50000 g/mol, and in the case of Ziegler at from 1 to 50 bar, from 20 to 150° C., titanium halides, titanic esters, or alkylaluminium compounds as catalysts, molar mass from about 200000 to 400000 g/mol. Conducted in suspension, solution, gas phase, or bulk. Very low level of branching, crystallinity from 60 to 80%, density from 0.942 to 0.965 g/cm³.
HMWHDPE (HMW=high molecular weight), obtainable by the Ziegler, Phillips, or gas-phase method, high density and high molar mass.
UHMWHDPE (UHMW=ultrahigh molecular weight), obtainable using modified Ziegler catalyst, molar mass from 3000000 to 6000000 g/mol.

Polyethylene prepared in a gas-phase fluidized-bed process using (usually supported) catalysts, e.g. Lupolen® (Basell), is particularly suitable.

Polyethylene prepared using metallocene catalysts is particularly preferred. An example of a commercially available polyethylene of this type is Luflexen® (Basell).

Suitable ethylene copolymers are any of the commercially available ethylene copolymers, such as Luflexen® grades (Basell), Nordel®, and Engage® (Dow, DuPont). Examples of suitable comonomers are α-olefins having from 3 to 10 carbon atoms, in particular propylene, 1-butene, 1-hexene, and 1-octene, and also C₁-C₂₀-alkyl acrylates and the corresponding methacrylates, in particular butyl acrylate. Other suitable comonomers are dienes, e.g. butadiene, isoprene, and octadiene. Other suitable comonomers are cycloolefins, such as cyclopentene, norbornene, and dicyclopentadiene.

The ethylene copolymers usually involve random copolymers or block copolymers or impact copolymers. Suitable block copolymers or impact copolymers composed of ethylene and of comonomers are polymers where in the first stage a homopolymer of the comonomer or a random copolymer of the comonomer, for example using up to 15% by weight of ethylene, is prepared, and in the second stage onto this a comonomer-ethylene copolymer, using ethylene contents of from 15 to 80% by weight, is polymerized. The amount of the comonomer-ethylene copolymer polymerized onto the first polymer is usually sufficient to give, within the final product, from 3 to 60% by weight content of the copolymer produced in the second stage.

The polymerization process for the preparation of the ethylene-comonomer copolymers can use a Ziegler-Natta catalyst system. However, it is also possible to use catalyst systems based on metallocene compounds or based on metal complexes having polymerization activity.

The main products produced from HDPE are toys, household articles, small engineering parts, and beer crates. Some grades of HDPE are used in single-use and bulk articles for everyday use. The application sector of LDPE extends from foils by way of papercoating as far as thick- and thin-walled moldings. LLDPE has advantages over LDPE in mechanical properties and in stress cracking resistance. LLDPE is mainly used in pipes and foils.

### Propylene Polymers:

The term polypropylene is intended hereinafter to mean not only homopolymers of propylene but also copolymers of propylene. Copolymers of propylene comprise subordinate amounts of monomers copolymerizable with propylene, examples being C₂-C₈₁-alkenes, inter alia, ethylene, 1-butene, 1-pentene, or 1-hexene. It is also possible to use two or more different comonomers.

Suitable polypropylenes are inter alia homopolymers of propylene or copolymers of propylene where the polymer incorporates up to 50% by weight of other 1-alkenes having up to 8 carbon atoms. The copolymers of propylene here are random copolymers or block copolymers or impact copolymers. When the copolymers of propylene have a random structure, they generally comprise up to 15% by weight, preferably up to 6% by weight, of other 1-alkenes having up to 8 carbon atoms, in particular ethylene, 1-butene or a mixture composed of ethylene and 1-butene.

Examples of suitable block copolymers or impact copolymers of propylene are polymers where in the first stage a propylene homopolymer or a random copolymer of propylene using up to 15% by weight, preferably up to 6% by weight, of other 1-alkenes having up to 8 carbon atoms, is prepared, and in the second stage onto this material, a propylene-ethylene copolymer using ethylene contents of from 15 to 80% by weight, the propylene-ethylene copolymer being able to comprise further C₄-C₈₁-alkenes, is polymerized. The amount of the propylene-ethylene copolymer polymerized onto the first material is generally such that, in the final product, the content of the copolymer produced in the second stage is from 3 to 60% by weight.

The polymerization process for preparation of polypropylene can use a Ziegler-Natta catalyst system. Catalyst systems used here are particularly those which comprise not only a titanium-containing solid component a), but also cocatalysts in the form of organoaluminum compounds b) and electron-donor compounds c).

However, it is also possible to use catalyst systems based on metallocene compounds or on metal complexes having polymerization activity.

The polypropylenes are usually prepared via polymerization in at least one reaction zone, and often in two or more reaction zones arranged in series (reactor cascade), in the gas phase, in a suspension, or in a liquid phase (bulk phase). The conventional reactors used for polymerization of C₂-C₈-1-alkenes can be used. Suitable reactors are inter alia continuously operated stirred tank reactors, loop reactors, powder-bed reactors, or fluidized-bed reactors.

The polymerization process for the preparation of the polypropylenes used is undertaken under conventional reaction conditions at temperatures of from 40 to 120° C., in particular from 50 to 100° C., and pressures of from 10 to 100 bar, in particular from 20 to 50 bar.

The melt flow rate (MFR) to ISO 1133 of suitable polypropylenes is generally from 0.1 to 200 g/10 min, in particular from 0.2 to 100 g/10 min, at 230° C. with a weight of 2.16 kg.

Another embodiment of the present invention relates to a polymer composition in which the polymer has been selected from copolymers of mono- or diolefins with vinyl monomers and mixtures thereof. Among these are ethylene-propylene copolymers, linear low-density polyethylene (LLDPE), and mixtures thereof with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers, and their copolymers with carbon monoxide, or ethylene-acrylic acid copolymers and their salts (ionomers), and terpolymers of ethylene with propylene and with a diene, such as hexadiene, dicyclopentadiene, or ethylidenenorbornene; and mixtures of these copolymers with one another and with polymers abovementioned in 1), e.g. polypropylene-ethylene-propylene copolymers, LDPE-ethylene-vinyl acetate copolymers (EVA), LDPE-ethylene-acrylic acid copolymers (EAA), LLDPE-EVA, LLDPE-EAA, and alternating or random polyalkylene-carbon monoxide copolymers, and mixtures thereof with other polymers, e.g. with polyamides.

Another preferred embodiment of the present invention provides a composition which comprises, as polymer, a polymer comprising halogen. Among the polymers comprising halogen are polytetrafluoroethylene homopolymers and polytetrafluoro-ethylene copolymers, polychloroprene, chlorinated and fluorinated rubbers, chlorinated and brominated isobutylene-isoprene copolymer (halogen rubber), chlorinated and sulfochlorinated polyethylene, copolymers of ethylene and of chlorinated ethylene and of chlorinated ethylene, epichlorohydrin homopolymers and epichlorohydrin copolymers, and in particular polymers of vinyl compounds comprising halogen, e.g. polyvinyl chloride (PVC), polyvinylidene chloride (PVDC), polyvinyl fluoride, polyvinylidene fluoride, and also copolymers thereof, e.g. vinyl chloride-vinylidene chloride copolymers, vinyl chloride-vinyl acetate copolymers, or vinylidene chloride-vinyl acetate copolymers. Polyvinyl chloride is used with varying content of plasticizers, in the form of rigid PVC with from 0 to 12% content of plasticizers, flexible PVC with more than 12%, or PVC paste with very high content of plasticizers. Examples of conventional plasticizers are phthalates, epoxides, adipic esters.

Polyvinyl chloride is prepared via free-radical polymerization of vinyl chloride in bulk, suspension, microsuspension, or emulsion polymerization processes. The polymerization process is often initiated via peroxides. PVC is widely used, for example as foamed synthetic leather, or as insulating wallpapers, household articles, shoe soles, furniture profiles, floorcoverings, or pipes.

Polyvinylidene chloride is prepared via free-radical polymerization of vinylidene chloride. Vinylidene chloride can also be copolymerized with (meth)acrylates, vinyl chloride, or acrylonitrile. Polyvinylidene chloride, and the vinylidene copolymers, are processed by way of example to give foils, or else to give profiles, pipes, or fibers. An important application relates to multilayer foils; the good barrier properties of polyvinylidene chloride are also used for coatings.

Another preferred embodiment of the present invention provides polymer compositions in which the polymer has been selected from homopolymers and copolymers of cyclic ethers, examples being polyalkylene glycols, e.g. polyethylene oxide, polypropylene oxide, or from copolymers thereof with bisglycidyl ethers. Polyalkylene glycols are produced via a polyaddition reaction of a cyclic ether, such as ethylene oxide, propylene oxide, or tetrahydrofuran, using an OH compound as starter molecule, an example being water. Starter molecules for the polyaddition reaction can also be di- or polyhydric alcohols. Low-molecular-weight polyalkylene glycols are used as synthetic lubricants. Polyalkylene glycols are moreover used as solubilizers for surfactant combinations, as binders in soaps, as constituents in inks and stamping inks, as plasticizers, and as release agents.

Another preferred embodiment of the present invention provides a polymer composition in which the polymer has been selected from polyacetals, copolymers composed of polyacetals using cyclic ethers and of polyacetals that have been modified by thermoplastic polyurethanes, by acrylates, or by methyl acrylate-butadiene-styrene copolymers. Polyacetals are produced via polymerization of aldehydes or of cyclic acetals. An industrially important polyacetal is polyoxymethylene (POM), obtainable via cationic or anionic polymerization of formaldehyde or trioxane. Modified POM is prepared by way of example via copolymerization using cyclic ethers, such as ethylene oxide or 1,3-dioxolane. The combination of POM with thermoplastic polyurethane elastomers gives POM-based polymer blends. Unreinforced POM features very high stiffness, strength, and toughness. POM is usually used for construction of household devices and for chemical engineering, vehicle construction, mechanical engineering, plumbing and pipe-fitting work.

Another preferred embodiment of the present invention provides a polymer composition in which the polymer has been selected from polyaryl ethers, polyaryl sulfides, and mixtures of polyaryl ethers with styrene polymers and polyamides. An example of polyaryl ethers is provided by polyphenylene oxides, the main chain of which is composed of phenylene units linked by way of oxygen atoms and, if appropriate, having substitution by alkyl groups. An industrially significant polyphenylene oxide is poly-2,6-dimethylphenyl ether. An example of polyaryl sulfides is provided by polyphenylene sulfides, which are obtainable via polycondensation of 1,4-dichlorobenzene with sodium sulfide. They feature high strength, stiffness, and hardness. They are a suitable substitute for metals in the construction of pump casings and in other elements in mechanical and chemical engineering. Electrical engineering and electronics are other application sectors for polyphenylene sulfides.

Another preferred embodiment of the present invention provides a polymer composition in which the polymer has been selected from polyurethanes. Examples of suitable polyisocyanate polyaddition products (polyurethane) are cellular polyurethanes, e.g. rigid or flexible polyurethane foams, compact polyurethanes, thermoplastic polyurethanes (TPU), thermoset or elastic polyurethanes, or polyisocyanurates. These are well known, and their production has been widely described. It generally uses reaction of bi- and polyfunctional isocyanates or of appropriate isocyanate analogues with compounds reactive toward isocyanates. Conventional production processes are used, examples being the one-shot process or the prepolymer process, e.g. in molds, in a reaction extruder, or else on a belt system. Reactive injection molding (RIM) is one specific production process which is preferably used for production of polyurethanes with a foamed or compact core and with a mainly compact, non-porous surface. The compound (I) and its derivatives are advantageously suitable for all of these processes.

Polyurethanes are generally composed of at least one polyisocyanate and at least one compound having at least two groups per molecule which are reactive toward isocyanate groups. Suitable polyisocyanates preferably have from 2 to 5 NCO groups. The groups reactive toward isocyanate groups are preferably selected from among hydroxy, mercapto, and primary and secondary amino groups. These include preferably di- or polyhydric polyols.

Suitable polyisocyanates are aliphatic, cycloaliphatic, araliphatic and aromatic isocyanates. Examples of suitable aromatic diisocyanates are diphenylmethane 2,2′-,2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyl-diphenyl diisocyanate, diphenylethane 1,2-diisocyanate and/or phenylene diisocyanate. Aliphatic and cycloaliphatic diisocyanates comprise, by way of example, tri-, tetra-, penta-, hexa-, hepta-, and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′-, and/or 2,2′-diisocyanate. Among the preferred diisocyanates are hexamethylene diisocyanate (HMDI) and isophorone diisocyanate. Examples of higher-functionality isocyanates are triisocyanates, e.g. triphenylmethane 4,4′,4″-triisocyanate, and the cyanurates of the abovementioned diisocyanates, and also the oligomers obtainable via partial reaction of diisocyanates with water, e.g. the biurets of the abovementioned diisocyanates, and also oligomers obtainable via controlled reaction of semiblocked diisocyanates with polyols, which have an average of more than 2, and preferably 3 or more, hydroxy groups.

The polyol components used here for rigid polyurethane foams, which may, if appropriate, have isocyanurate structures, are high-functionality polyols, in particular polyether polyols based on high-functionality alcohols, sugar alcohols, and/or saccharides as starter molecules. For flexible polyisocyanate polyaddition products, e.g. flexible polyurethane foams or RIM materials, preferred polyols are di- and/or trifunctional polyether polyols based on glycerol and/or on trimethylolpropane and/or on glycols as starter molecules, and di- and/or trifunctional polyester polyols based on glycerol and/or on trimethylolpropane and/or on glycols as alcohols for esterification. Thermoplastic polyurethanes are usually based on mainly difunctional polyester polyalcohols and/or on polyether polyalcohols which preferably have an average functionality of from 1.8 to 2.5, particularly preferably from 1.9 to 2.1.

As stated above, the polyurethane preferably involves at least one polyether polyurethane, particularly preferably at least one polytetrahydrofuran polyether urethane. One specific embodiment is provided by thermoplastic polyurethanes which are based on predominantly difunctional polyether polyalcohols.

The preparation of these polyether polyols follows known technology. Examples of suitable alkylene oxides for the preparation of the polyols are propylene 1,3-oxide, butylene 1,2- or 2,3-oxide, styrene oxide, and preferably ethylene oxide and propylene 1,2-oxide. The alkylene oxides may be used individually, alternating in succession, or in the form of mixtures. It is preferable to use alkylene oxides which give primary hydroxy groups in the polyol. Polyols particularly preferably used are those which have been alkoxylated with ethylene oxide to conclude the alkoxylation process, and therefore have primary hydroxy groups. Other suitable polyetherols are polytetra-hydrofurans and polyoxymethylenes. The polyether polyols preferably have a functionality of from 2 to 6, in particular from 2 to 4, and have molecular weights of from 200 to 10000, preferably from 200 to 8000. Suitable polytetrahydrofurans are compounds of the general formula

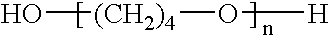

where n=from 2 to 200, preferably from 3 to 150, and mixtures thereof. These polytetrahydrofurans preferably have a number-average molecular weight in the range from 200 to 100000, preferably from 250 to 8000. Suitable polytetrahydrofurans can be produced via cationic polymerization of tetrahydrofuran in the presence of acidic catalysts, e.g. sulfuric acid or fluorosulfuric acid. Production processes of this type are known to the person skilled in the art.

By way of example, suitable polyester polyols may be prepared from organic dicarboxylic acids having from 2 to 12 carbon atoms, preferably aliphatic dicarboxylic acids having from 4 to 6 carbon atoms, and from polyfunctional alcohols, preferably diols, having from 2 to 12 carbon atoms, preferably from 2 to 6 carbon atoms. The polyester polyols preferably have a functionality of from 2 to 4, in particular from 2 to 3, and a molecular weight of from 480 to 3000, preferably from 600 to 2000, and in particular from 600 to 1500.

The polyol component may also comprise diols or higher-functionality alcohols. Suitable diols are glycols preferably having from 2 to 25 carbon atoms. Among these are 1,2-ethanediol, 1,2-propanediol, 1,3-propanediol, 1,4-butanediol, 1,5-pentanediol, 1,6-hexanediol, 1,10-decanediol, diethylene glycol, 2,2,4-trimethyl-1,5-pentanediol, 2,2-dimethyl-1,3-propanediol, 1,4-dimethylolcyclohexane, 1,6-dimethylolcyclohexane, 2,2-bis(4-hydroxyphenyl)propane (bisphenol A), 2,2-bis(4-hydroxyphenyl)butane (bisphenol B), or 1,1-bis(4-hydroxyphenyl)-3,3,5-trimethylcyclohexane (bisphenol C). Examples of suitable higher-functionality alcohols are trifunctional alcohols (triols), tetrafunctional alcohols (tetrols), and/or pentafunctional alcohols (pentols). They generally have from 3 to 25, preferably from 3 to 18, carbon atoms. Among these are glycerol, trimethylolethane, trimethylolpropane, erythritol, pentaerythritol, sorbitol and alkoxylates of these.

However, it can prove advantageous to add chain extenders, crosslinking agents, stoppers, or else, if appropriate, mixtures of these in order to modify mechanical properties such as hardness. By way of example, the chain extenders and/or crosslinking agents have a molecular weight of from 40 to 300. Examples of those which may be used are aliphatic, cycloaliphatic, and/or araliphatic diols having from 2 to 14, preferably from 2 to 10, carbon atoms, e.g. ethylene glycol, 1,3-propanediol, 1,2-propanediol, 1,10-decanediol, 1,2-, 1,3-, 1,4-dihydroxycyclohexane, diethylene glycol, dipropylene glycol, and preferably ethylene glycol, 1,4-butanediol, 1,6-hexanediol, and bis(2-hydroxyethyl)hydroquinone, triols, e.g. 1,2,4- or 1,3,5-trihydroxycyclohexane, glycerol, trimethylolpropane, triethanolamine, and low-molecular-weight hydroxy-comprising polyalkylene oxides based on ethylene oxide and/or on propylene 1,2-oxide, and on the abovementioned diols and/or triols as starter molecules. Examples of suitable stoppers comprise monofunctional alcohols or secondary amines.

Another preferred embodiment of the present invention provides a polymer composition in which the polymer has been selected from polyureas, polyimides, polyamideimides, polyetherimides, polyesterimides, polyhydantoins, and polybenzimidazoles. Polyureas are known to be produced via polyaddition of diamines and diisocyanates. Polyimides, the essential structural element of which is the imide group in the main chain, are produced via reaction of aromatic tetracarboxylic dianhydrides with aliphatic or aromatic diamines. Polyimides are used inter alia as adhesives in composite materials, and also coatings, thin foils, for example as insulating material in microelectronics, and for high-modulus fibers, for semipermeable membranes, and as liquid-crystalline polymers.

Another preferred embodiment of the present invention provides a polymer composition in which the polymer has been selected from polyesters, preferably at least one linear polyester. Suitable polyesters and copolyesters have been described in EP-A-0678376, EP-A-0 595 413, and U.S. Pat. No. 6,096,854, which are incorporated herein by way of reference. Polyesters are known to be condensates composed of one or more polyols and of one or more polycarboxylic acids. In linear polyesters, the polyol is a diol and the polycarboxylic acid is a dicarboxylic acid. The diol component can be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, and 1,3-cyclohexanedimethanol. Other diols that can be used are those whose alkylene chain has one or more interruptions via non-adjacent oxygen atoms. Among these are diethylene glycol, triethylene glycol, dipropylene glycol, tripropylene glycol, and the like. The diol generally comprises from 2 to 18 carbon atoms, preferably from 2 to 8 carbon atoms. Cycloaliphatic diols can be used in the form of their cis or trans isomers or in the form of an isomer mixture. The acid component can be an aliphatic, alicyclic, or aromatic dicarboxylic acid. The acid component of linear polyesters is generally selected from terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, and mixtures thereof. It is, of course, also possible to use the functional derivatives of the acid component, examples being esters, e.g. the methyl ester, anhydrides, or halides, preferably chlorides. Preferred polyesters are polyalkylene terephthalates, and polyalkylene napthalates, which are obtainable via condensation of terephthalic acid and, respectively, naphthalenedicarboxylic acid with an aliphatic diol.

Preferred polyalkylene terephthalates are polyethylene terephthalates (PET), which are obtained via condensation of terephthalic acid with diethylene glycol. PET is moreover also obtainable via transesterification of dimethyl terephthalate with ethylene glycol with elimination of methanol to give bis(2-hydroxyethyl) terephthalate and polycondensation thereof with liberation of ethylene glycol. Other preferred polyesters are polybutylene terephthalates (PBT), which are obtainable via condensation of terephthalic acid with 1,4-butanediol, polyalkylene naphthalates (PAN), such as polyethylene 2,6-naphthalates (PEN), poly-1,4-cyclohexanedimethylene terephthalates (PCT), and copolyesters of polyethylene terephthalate with cyclohexanedimethanol (PDCT), and copolyesters of polybutylene terephthalate with cyclohexanedimethanol. Preference is likewise given to copolymers, transesterification products, and physical mixtures (blends) of the abovementioned polyalkylene terephthalates. Particularly suitable polymers are those selected from poly- or copolycondensates of terephthalic acid, e.g. poly- or copolyethylene terephthalate (PET or CoPET or PETG), poly(ethylene 2,6-naphthalate)s (PEN), or PEN/PET copolymers, and PEN/PET blends. The copolymers and blends mentioned can also comprise, as a function of their preparation process, fractions of transesterification products.

PET and PBT are widely used for production of fibers and also have high stability as thermoplastic materials for engineering parts, such as bearings, gearwheels, cam wheels, rollers, switch casings, plugs, grips, control buttons. PET is widely used as a material for drinks bottles.

Another preferred embodiment of the present invention provides a polymer composition in which the polymer is selected from polycarbonates, polyester carbonates, and mixtures thereof. Polycarbonates are produced by way of example via condensation of phosgene or of carbonic esters, such as diphenyl carbonate or dimethyl carbonate, with dihydroxy compounds. Suitable dihydroxy compounds are aliphatic or aromatic dihydroxy compounds. Examples which may be mentioned of aromatic dihydroxy compounds are bisphenols, such as 2,2-bis(4-hydroxyphenyl)propane (bisphenol A), tetraalkylbisphenol A, 4,4-(meta-phenylenediisopropyl)diphenol (bisphenol M), 4,4-(para-phenylenediisopropyl)diphenol, 1,1-bis(4-hydroxyphenyl)-3,3,5-trimethyl-cyclohexane (BP-TMC), 2,2-bis(4-hydroxyphenyl)-2-phenylethane, 1,1-bis(4-hydroxy-phenyl)cyclohexane (bisphenol Z), and, if appropriate, their mixtures. The polycarbonates can be branched via use of very small amounts of branching agents. Among the suitable branching agents are phloroglucinol, 4,6-dimethyl-2,4,6-tri(4-hydroxyphenyl)-2-heptene, 4,6-dimethyl-2,4,6-tri(4-hydroxyphenyl)heptane; 1,3,5-tri(4-hydroxyphenyl)benzene; 1,1,1-tri(4-hydroxyphenyl)heptane; 1,3,5-tri(4-hydroxy-phenyl)benzene; 1,1,1-tri(4-hydroxyphenyl)ethane; tri(4-hydroxyphenyl)phenylmethane, 2,2-bis[4,4-bis(4-hydroxyphenyl)cyclohexyl]propane; 2,4-bis(4-hydroxy-phenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenyl-isopropyl)phenyl) orthoterephthalate; tetra(4-hydroxyphenyl)methane; tetra(4-(4-hydroxyphenylisopropyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole, 1,4-bis(4′,4″-dihydroxy-triphenyl)methyl)benzene, and in particular 1,1,1-tri(4-hydroxyphenyl)ethane, and bis(3-methyl-4-hydroxyphenyl)-2-oxo-2,3-dihydroindole.

Examples of suitable chain terminators are phenols, such as phenol, alkylphenols, such as cresol and 4-tert-butylphenol, chlorophenol, bromophenol, cumylphenol, or their mixtures. The proportion of chain terminators is generally from 1 to 20 mol % per mole of dihydroxy compound.

Another preferred embodiment of the present invention provides a polymer composition in which the polymer has been selected from polysulfones, polyether sulfones, polyether ketones, and mixtures thereof. Polyether ketones are used by way of example in the electrical industry and in vehicle construction.

Another preferred embodiment of the present invention provides a polymer composition in which the polymer has been selected from synthetic resins. Among synthetic resins are crosslinked polymers which derive on the one hand from aldehydes and on the other hand from phenols, ureas, and melamines, examples being phenol-formaldehyde resins, urea-formaldehyde resins, and melamine-formaldehyde resins. Likewise among the synthetic resins are drying and non-drying alkyd resins and unsaturated polyester resins, derived from copolyesters of saturated and unsaturated dicarboxylic acids with polyhydric alcohols and vinyl compounds as crosslinking agents, and also modifications thereof with low flammability comprising halogen. Among the synthetic resins are moreover crosslinkable acrylic resins which derive from substituted acrylates, e.g. epoxy acrylates, urethane acrylates, or polyester acrylates. Among the synthetic resins are moreover alkyd resins, polyester resins, and acrylate resins crosslinked by melamine resins, by urea resins, by isocyanates, by isocyanurates, by polyisocyanates, or by epoxy resins, and crosslinked epoxy resins which derive from aliphatic, cycloaliphatic, heterocyclic or aromatic glycidyl compounds. Epoxy resins are known to be produced via ring-opening crosslinking reaction of polyfunctional epoxides. Examples of epoxy resins comprise diglycidyl ether of bisphenol A or bisphenol F. They can be crosslinked by anhydrides or by amines, with or without accelerator. Among the synthetic resins are also hydrocarbon resins, whose molecular weight is usually below 2000. The hydrocarbon resins can be divided into three groups: petroleum resins, terpene resins, and coal tar resins. Among the hydrocarbon resins for the purposes of this invention are also the hydrogenated modifications thereof and polyalkylenes.

Another preferred embodiment of the present invention provides a polymer composition in which the polymer has been selected from naturally occurring polymers, such as cellulose, rubber, gelatin, and chemically modified derivatives thereof, e.g. cellulose acetates, cellulose propionates, and cellulose butyrates, or the cellulose ethers, such as methylcellulose; and colophony and its derivatives.

Cellulose is mainly used in a mixture with PET fibers in the clothing sector; it is also used in the form of rayon, linings, drapery, tire cord, wadding, wound-dressing materials, and hygiene items. Cellulose esters are processed by way of example to give screwdriver grips, spectacle frames, brushes, combs, ballpoint pens, engineering parts, such as motor-vehicle steering wheels, lamp covers, device covers, word-processor keys, electrically insulating foils, films for photographic purposes, and light- and heat-resistant thermoplastic binders for lacquers. Cellulose ethers serve as binders for transparent coatings for textiles, paper, foils and metals. Natural rubber (1,4-cis-polyisoprene) is indispensable for many applications, such as radial tires.

Another preferred embodiment of the present invention provides a polymer composition in which the polymer has been selected from naturally occurring and synthetic organic materials which are pure monomeric compounds or mixtures of compounds of this type, e.g. mineral oils, animal and vegetable fats, oil, and waxes, or oils, fats, and waxes based on synthetic esters, e.g. phthalates, adipates, phosphates, or trimellitates, and mixtures of synthetic esters with mineral oils in any desired ratios by weight, generally those used as spinning agents, and aqueous emulsions of these materials.

Another preferred embodiment of the present invention provides a polymer composition where the polymer has been selected from aqueous emulsions of naturally occurring or synthetic rubber. Among the aqueous emulsions of naturally occurring or synthetic rubber are natural latex or latices of carboxylated styrene-butadiene copolymers.

Another preferred embodiment of the invention provides a polymer composition in which the polymer has been selected from polymers which derive from unsaturated alcohols and amines or from their acyl derivatives or acetals, e.g. polyvinyl acetate (PVAC) and polyvinyl alcohol (PVAL). Reaction of polyvinyl alcohol with an aldehyde produces polyvinyl acetals, for example polyvinyl formals (PVFM) in the case of reaction with formaldehyde, or the polyvinyl butyrals (PVB) with butyraldehyde. Polyvinyl compounds have a low glass transition temperature and are therefore polymer resins rather than thermoplastic materials. They are used as coating compositions, for example for carpet-backing coatings, cheese coatings, paper coatings, lacquer binders, pigment binders, as a raw material for lacquers, as glues, as adhesives, as protective colloids, as chewing-gum base, as concrete additive, as foils for production of composite glazing for windshields of motor vehicles, and they are also used for many other purposes.

Another preferred embodiment of the invention provides a polymer composition in which the polymer has been selected from polyamides (abbreviated PA) or from copolyamides, which have amides as essential structural elements in the main polymer chain. Polyamides can, by way of example, be prepared via polycondensation from diamines and dicarboxylic acids or from their derivatives. Examples of suitable diamines are alkyldiamines, such as C₂-C₂₀-alkyldiamines, e.g. hexamethylenediamine, or aromatic diamines, such as C₆-C₂₀-aromatic diamines, e.g. m-, o-, or p-phenylene-diamine or m-xylenediamine. Suitable dicarboxylic acids comprise aliphatic dicarboxylic acids or their derivatives, for example chlorides, such as C₂-C₂₀-aliphatic dicarboxylic acids, e.g. sebacic acid, decanedicarboxylic acid, or adipic acid, or aromatic dicarboxylic acids, such as C₆-C₂₀-aromatic dicarboxylic acids or their derivatives, for example chlorides, such as 2,6-naphthalenedicarboxylic acid, isophthalic acid, or terephthalic acid. Examples of these polyamides are poly-2,4,4-trimethyl-hexamethyleneterephthalamide or poly-m-phenyleneisophthalamide, PA 6,6 (polyhexamethyleneadipamide), PA 4,6 (polytetramethyleneadipamide), PA 6,10 (polyhexamethylenesebacamide), PA 6/9, PA 6/12, PA 4/6, PA 12/12, where the first number always states the number of carbon atoms in the diamine and the second number always states the number of carbon atoms in the dicarboxylic acid.

Polyamides are likewise obtainable via polycondensation from an amino acid, such as C₂-C₂₀ amino acids, e.g. 6-aminocaproic acid, 11-aminoundecanoic acid, or via ring-opening polymerization from lactams, e.g. caprolactam. Examples of these polyamides are PA 4 (composed of 4-aminobutyric acid), PA 6 (composed of 6-aminohexanoic acid). PA 11 is, for example, a polyundecanolactam, and PA 12 is a polydodecanolactam. In the case of polyamides which, as in this case, are composed only of one monomer, the numeral after the abbreviation PA states the number of carbon atoms in the monomer.

Polyamides can, if appropriate, be prepared with an elastomer as modifier. Examples of suitable copolyamides are block copolymers of the abovementioned polyamides with polyolefins, with olefin copolymers, with ionomers, or with chemically bonded or grafted elastomers; or with polyethers, for example with polyethylene glycol, polypropylene glycol, or polytetramethylene glycol; and polyamides or copolyamides modified with EPDM or ABS; and polyamides condensed during processing (RIM polyamide systems).

Polyamide is used in injection-molded parts with stringent requirements for toughness, abrasion resistance, and thermal stability (dimensional stability), examples being plastics components in the engine compartment of automobiles, and other examples being gearwheels, etc. Polyamide is also used in synthetic fibers (e.g. nylon, Perlon).

Another preferred embodiment of the present invention provides a polymer composition in which the polymer has been selected from polymers derived from α,β-unsaturated acids and from their derivatives, examples being polyacrylates and polymethacrylates; polymethyl methacrylates (PMMA), polyacrylamides (PAA), and polyacrylonitriles (PAC), impact-modified with butyl acetate. Polyacrylic acids are known to be produced via polymerization of acrylic acid. The polymerization process can be carried out as a solution polymerization in water, as a precipitation polymerization, for example in benzene, or as a suspension polymerization.

Polyacrylic acid is used in the form of its salts as thickener and in aqueous media for coatings. Polyacrylic acid and its copolymers with acrylamide are used as suspending agent for pigments, as flocculant in water treatment, as drilling aid in mining, as paper auxiliary, as adhesive for metal/plastics bonds, and for many other purposes. Polyacrylates are mainly used as binders for paints and lacquers, in the paper industry in coating compositions and as binders and sizes, for textile finishing, in adhesives and sealing compositions, as leather auxiliaries, as elastomers, and for many other purposes. A major application sector for PMMA is use as hardener component in binders of lacquer resins. In combination with acrylates it gives high-quality coatings featuring durability, film toughness, gloss, and weather resistance. These resins are used in primers and coatings, emulsion paints and dispersion-based lacquers. PAA is mainly used as a flocculant in water treatment, as paper auxiliary, and as a floatation aid in mining. It is also used as a clarification aid for fruit juices, a textile auxiliary, a crosslinking agent in coatings, e.g. in the leather industry, as a thickener in paint dispersions, in adhesives, and in many other uses. Application sectors for PAC are knitted products, home textiles (e.g. covers, curtains, upholstery), and carpets.

Another preferred embodiment of the present invention provides a polymer composition in which the polymer has been selected from copolymers of the monomers mentioned in the above paragraph, with one another or with other unsaturated monomers, examples being acrylonitrile-butadiene copolymers, acrylonitrile-alkyl acrylate copolymers, acrylonitrile-alkoxyalkyl acrylate or acrylonitrile-vinyl halide copolymers, or acrylonitrile-alkyl methacrylate-butadiene terpolymers.

Another preferred embodiment of the present invention provides a polymer composition in which the polymer has been selected from polystyrene, poly(p-methylstyrene), poly(α-methylstyrene), copolymers of styrene or α-methylstyrene with dienes or acrylic derivatives or graft copolymers of styrene or α-methylstyrene.

Unmodified styrene polymers can be processed to give foams which are then used in the construction industry and in packaging. Copolymers of styrene or α-methylstyrene with dienes or with acrylic derivatives comprise styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures, with high impact resistance, of styrene copolymers and another polymer, e.g. a polyacrylate, a diene polymer, or an ethylene-propylene-diene terpolymer; and block copolymers of styrene, such as styrene-butadiene-styrene, styrene-isoprene-styrene, styrene-ethylene-butylene-styrene, or styrene-ethylene-propylene-styrene.

Graft copolymers of styrene or α-methylstyrene, e.g. styrene on polybutadiene, styrene on polybutadiene-styrene or polybutadiene-acrylonitrile copolymers; styrene and acrylonitrile (or methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene; styrene and alkyl acrylates or alkyl methacrylates on polybutadiene; styrene and acrylonitrile on ethylene-propylene-diene terpolymers; styrene and acrylonitrile on polyalkyl acrylates or polyalkyl methacrylates, styrene and acrylonitrile on acrylate-butadiene copolymers, and mixtures thereof with polyureas, with polyimides, with polyamideimides, with polyetherimides, with polyesterimides, with polyhydantoins, and with polybenzimidazoles, e.g. the copolymer mixtures known as ABS polymers, MBS polymers, ASA polymers, or AES polymers.

The most important applications for ABS are components, e.g. housings for electrical and electronic devices (telephones), automobile parts.

Another preferred embodiment of the present invention provides a polymer composition where the polymer is a polymer blend. The expression “polymer blend” means a mixture composed of two or more polymers or copolymers. Polymer blends serve to improve the properties of the underlying component.

Examples of polymer blends comprise PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylates, POM/MBS, PPO/HIPS, PPO/PA 6,6 and copolymers, PA/HDPE, PA/PP, PA/PPO, PBT/PC/ABS or PBT/PET/PC.

Acrylonitrile-butadiene-styrene copolymers (ABS) are thermoplastic or elastic polymer blends. They are prepared via graft polymerization of the three underlying monomers acrylonitrile, butadiene, and styrene in an emulsion polymerization process or bulk polymerization process. The properties of ABS can be controlled by way of the quantitative proportions of the monomers used.

The inventive polymer composition can comprise at least one additive, preferably selected from colorants, antioxidants, light stabilizers, metal deactivators, antistatic agents, reinforcing materials and fillers, antifogging agent, biocides, and additives other than these.

For the purposes of the invention, the expression colorant comprises both dyes and pigments. The pigment can be an inorganic or organic pigment. Organic compounds which fluoresce in the visible part of the electromagnetic spectrum, e.g. fluorescent dyes, are likewise regarded as colorants. In principle, any of the colorants which permit laser marking of plastics parts in which they are used as additives is suitable.

Examples of suitable inorganic colorant pigments are white pigments, such as titanium dioxide in its three crystalline forms: rutile, anatase, or brookite, white lead, zinc white, zinc sulfide, or lithopones; black pigments, such as carbon black, iron oxide black, iron manganese black, or spinel black; chromatic pigments, such as chromium oxide, chromium oxide hydrate green, cobalt green, or ultramarine green, cobalt blue, iron blue, Milori blue, ultramarine blue or manganese blue, ultramarine violet or cobalt/manganese violet, iron oxide red, cadmium sulfoselenide, molybdate red or ultramarine red; iron oxide brown, mixed brown, spinel/corundum phases or chromium orange; iron oxide yellow, nickel titanium yellow, chromium titanium yellow, cadmium sulfide, cadmium zinc sulfide, chromium yellow, zinc yellow, alkaline earth metal chromates, Naples yellow; bismuth vanadate, interference pigments, luster pigments, and special-effect pigments.

Suitable inorganic pigments comprise: Pigment White 6, Pigment White 7, Pigment Black 7, Pigment Black 11, Pigment Black 22, Pigment Black 27/30, Pigment Yellow 34, Pigment Yellow 35/37, Pigment Yellow 42, Pigment Yellow 53, Pigment Brown 24, Pigment Yellow 119, Pigment Yellow 184, Pigment Orange 20, Pigment Orange 75, Pigment Brown 6, Pigment Brown 29, Pigment Brown 31, Pigment Yellow 164, Pigment Red 101, Pigment Red 104, Pigment Red 108, Pigment Red 265, Pigment Violet 15, Pigment Blue 28/36, Pigment Blue 29, Pigment Green 17, Pigment Green 26/50.

The colorant is preferably an organic pigment or an organic dye, in particular a transparent colorant.

Examples of suitable organic pigments are aniline black, anthrapyrimidine pigments, azomethine pigments, anthraquinone pigments, monoazo pigments, bisazo pigments, benzimidazolone pigments, quinacridone pigments, quinophthalone pigments, diketopyrrolopyrrole pigments, dioxazine pigments, flavanthrone pigments, indanthrone pigments, indolinone pigments, isoindoline pigments, isoindolinone pigments, thioindigo pigments, metal complex pigments, perinone pigments, perylene pigments, pyranthrone pigments, phthalocyanine pigments, thioindigo pigments, or triarylcarbonium pigments.

Suitable organic pigments comprise: examples of organic pigments are: C.I. (Colour Index) Pigment Yellow 93, C.I. Pigment Yellow 95, C.I. Pigment Yellow 138, C.I. Pigment Yellow 139, C.I. Pigment Yellow 155, C.I. Pigment Yellow 162, C.I. Pigment Yellow 168, C.I. Pigment Yellow 180, C.I. Pigment Yellow 183, C.I. Pigment Red 44, C.I. Pigment Red 170, C.I. Pigment Red 202, C.I. Pigment Red 214, C.I. Pigment Red 254, C.I. Pigment Red 264, C.I. Pigment Red 272, C.I. Pigment Red 48:2, C.I. Pigment Red 48:3, C.I. Pigment Red 53:1, C.I. Pigment Red 57:1, C.I. Pigment Green 7, C.I. Pigment Blue 15:1, C.I. Pigment Blue 15:3, C.I. Pigment Violet 19.

Some of the pigments mentioned, e.g. carbon black or titanium dioxide, can also function as filler or reinforcing material, and/or as nucleating agent.

Another possible group of additives are agents added to modify appearance, mechanical properties, or else surface feel, e.g. matting agents, such as titanium dioxide, chalk, barium sulfate, zinc sulfide, fillers, such as nanoparticulate silicon dioxide, aluminum hydroxide, loam, and other phyllosilicates, glass fibers and glass beads.

UV stabilizers that can be used are commercially available compounds. The stabilizer component can be added in solid or liquid form before, during or after the preparation of the polymer. The pigment component and the stabilizer component can also be incorporated together or in succession before, during or after the preparation of the polymer.

The inventive polymer composition usually comprises at least one UV-stabilizer in an amount of from 0.01 to 5% by weight, preferably from 0.02 to 2.5% by weight, and particularly preferably from 0.01 to 1.0% by weight, based on the total weight of the composition.

The inventive composition can moreover comprise at least one additive selected from antioxidants, metal deactivators, antistatic agents, reinforcing materials, fillers, antifogging agents, and biocides.

The antioxidants, light stabilizers, and metal deactivators used if appropriate preferably have high migration resistance and thermal stability. Suitable antioxidants, light stabilizers, and metal deactivators are, by way of example, selected from groups a) to s):

a) 4,4-diarylbutadienes,
b) cinnamic esters,
c) benzotriazoles,
d) hydroxybenzophenones,
e) diphenylcyanoacrylates,
f) oxamides (oxalic diamides),
g) 2-phenyl-1,3,5-triazines;
h) antioxidants,
i) nickel compounds,
j) sterically hindered amines,
k) metal deactivators,
l) phosphites and phosphonites,
m) hydroxylamines,
n) nitrones,
o) amine oxides,
p) benzofuranones and indolinones,
q) thiosynergists,
r) peroxide-destroying compounds, and
s) basic costabilizers.

The group a) of the 4,4-diarylbutadienes includes, for example, compounds of the formula A.

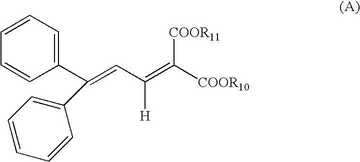

The compounds are known from EP-A-916 335. The R₁₀ and/or R₁₁ substituents are preferably C₁-C₈-alkyl and C₅-C₈-cycloalkyl.

The group b) of the cinnamic esters includes, for example, isoamyl 4-methoxy-cinnamate, 2-ethylhexyl 4-methoxycinnamate, methyl α-(methoxycarbonyl)cinnamate, methyl α-cyano-β-methyl-p-methoxycinnamate, butyl α-cyano-β-methyl-p-methoxy-cinnamate and methyl α-(methoxycarbonyl)-p-methoxycinnamate.

The group c) of the benzotriazoles includes, for example, 2-(2′-hydroxyphenyl)benzo-triazoles, such as 2-(2′-hydroxy-5′-methylphenyl)benzotriazole, 2-(3′,5′-di(tert-butyl)-2′-hydroxyphenyl)benzotriazole, 2-(5′-(tert-butyl)-2′-hydroxyphenyl)benzotriazole, 2-(2′-hydroxy-5′-(1,1,3,3-tetramethylbutyl)phenyl)benzotriazole, 2-(3′,5′-di(tert-butyl)-2′-hydroxyphenyl)-5-chlorobenzotriazole, 2-(3′-(tert-butyl)-2′-hydroxy-5′-methylphenyl)-5-chlorobenzotriazole, 2-(3′-(sec-butyl)-5′-(tert-butyl)-2′-hydroxyphenyl)benzotriazole, 2-(2′-hydroxy-4′-octyloxyphenyl)benzotriazole, 2-(3′,5′-di(tert-amyl)-2′-hydroxyphenyl)-benzotriazole, 2-(3′,5′-bis(α,α-dimethylbenzyl)-2′-hydroxyphenyl)benzotriazole, 2-(3′-(tert-butyl)-2′-hydroxy-5′-(2-octyloxycarbonylethyl)phenyl)-5-chlorobenzotriazole, 2-(3′-(tert-butyl)-5′-[2-(2-ethylhexyloxy)carbonylethyl]-2′-hydroxyphenyl)-5-chlorobenzo-triazole, 2-(3′-(tert-butyl)-2′-hydroxy-5′-(2-methoxycarbonylethyl)phenyl)-5-chlorobenzo-triazole, 2-(3′-(tert-butyl)-2′-hydroxy-5′-(2-methoxycarbonylethyl)phenyl)benzotriazole, 2-(3′-(tert-butyl)-2′-hydroxy-5′-(2-octyloxycarbonylethyl)phenyl)benzotriazole, 2-(3′-(tert-butyl)-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-(tert-butyl)-2′-hydroxy-5′-(2-isooctyloxycarbonylethyl)phenyl)benzotriazole, 2,2′-methylenebis[4-(1,1,3,3-tetra-methylbutyl)-6-(benzotriazol-2-yl)phenol], the product of esterification of 2-[3′-(tert-butyl)-5′-(2-methoxycarbonylethyl)-2′-hydroxyphenyl]-2H-benzotriazole with polyethylene glycol 300, [R—CH₂CH₂—COO(CH₂)₃]₂, where R=3′-(tert-butyl)-4′-hydroxy-5′-(2H-benzotriazol-2-yl)phenyl, and mixtures thereof.

The group d) of the hydroxybenzophenones includes, for example, 2-hydroxybenzo-phenones, such as 2-hydroxy-4-methoxybenzophenone, 2,2′-dihydroxy-4-methoxy-benzophenone, 2,4-dihydroxybenzophenone, 2,2′,4,4′-tetrahydroxybenzophenone, 2,2′-dihydroxy-4,4′-dimethoxybenzophenone, 2,2′-dihydroxy-4,4′-dimethoxybenzo-phenone, 2-hydroxy-4-(2-ethylhexyloxy)benzophenone, 2-hydroxy-4-(n-octyloxy)benzo-phenone, 2-hydroxy-4-methoxy-4′-methylbenzophenone, 2-hydroxy-3-carboxybenzo-phenone, 2-hydroxy-4-methoxybenzophenone-5-sulfonic acid and its sodium salt, and 2,2′-dihydroxy-4,4′-dimethoxybenzophenone-5,5′-disulfonic acid and its sodium salt.

The group e) of the diphenylcyanoacrylates includes, for example, ethyl 2-cyano-3,3-diphenylacrylate, which, for example, is obtainable commercially as Uvinul® 3035 from BASF AG, Ludwigshafen, 2-ethylhexyl 2-cyano-3,3-diphenylacrylate, which, for example, is obtainable commercially as Uvinul® 3039 from BASF AG, Ludwigshafen, and 1,3-bis[(2′-cyano-3′,3′-diphenylacryloyl)oxy]-2,2-bis{[(2′-cyano-3′,3′-diphenyl-acryloyl)oxy]methyl}propane, which, for example, is obtainable commercially as Uvinul® 3030 from BASF AG, Ludwigshafen.

The group f) of the oxamides includes, for example, 4,4′-dioctyloxyoxanilide, 2,2′-di-ethoxyoxanilide, 2,2′-dioctyloxy-5,5′-di(tert-but)oxanilide, 2,2′-didodecyloxy-5,5′-di(tert-but)oxanilide, 2-ethoxy-2′-ethyloxanilide, N,N′-bis(3-dimethylaminopropyl)oxamide, 2-ethoxy-5-(tert-butyl)-2′-ethoxanilide and its mixture with 2-ethoxy-2′-ethyl-5,4′-di(tert-butyloxanilide, and also mixtures of ortho- and para-methoxy-disubstituted oxanilides and mixtures of ortho- and para-ethoxy-disubstituted oxanilides.

The group g) of the 2-phenyl-1,3,5-triazines includes, for example, 2-(2-hydroxy-phenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-di-hydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-di-methylphenyl)-1,3,5-triazine, 2-(2-hydroxy-4-tridecyloxyphenyl)-4,6-bis(2,4-dimethyl-phenyl)-1,3,5-triazine, 2-[2-hydroxy-4-(2-hydroxy-3-(butyloxy)propoxy)phenyl]-4,6-bis(2,4-dimethylphenyl)-1,3,5-triazine, 2-[2-hydroxy-4-(2-hydroxy-3-(octyloxy)propoxy)-phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-(dodecyloxy)propoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

The group h) of the antioxidants comprises, for example:

alkylated monophenols, for example 2,6-di(tert-butyl)-4-methylphenol, 2-(tert-butyl)-4,6-dimethylphenol, 2,6-di(tert-butyl)-4-ethylphenol, 2,6-di(tert-butyl)-4-(n-butyl)phenol, 2,6-di(tert-butyl)-4-isobutylphenol, 2,6-dicyclopentyl-4-methylphenol, 2-α-methyl-cyclohexyl)-4,6-dimethylphenol, 2,6-dioctadecyl-4-methylphenol, 2,4,6-tricyclo-hexylphenol, 2,6-di(tert-butyl)-4-methoxymethylphenol, unbranched nonylphenols or nonylphenols which are branched in the side chain, such as, for example, 2,6-dinonyl-4-methylphenol, 2,4-dimethyl-6-(1-methylundec-1-yl)phenol, 2,4-dimethyl-6-(1-methyl-heptadec-1-yl)phenol, 2,4-dimethyl-6-(1-methyltridec-1-yl)phenol and mixtures thereof.

Alkylthiomethylphenols, for example 2,4-dioctylthiomethyl-6-(tert-butyl)phenol, 2,4-dioctylthiomethyl-6-methylphenol, 2,4-dioctylthiomethyl-6-ethylphenol and 2,6-didodecylthiomethyl-4-nonylphenol.

Hydroquinones and alkylated hydroquinones, for example 2,6-di(tert-butyl)-4-methoxyphenol, 2,5-di(tert-butyl)hydroquinone, 2,5-di(tert-amyl)hydroquinone, 2,6-diphenyl-4-octadecyloxyphenol, 2,6-di(tert-butyl)hydroquinone, 2,5-di(tert-butyl)-4-hydroxyanisole, 3,5-di(tert-butyl)-4-hydroxyanisole, 3,5-di(tert-butyl)-4-hydroxyphenyl stearate and bis(3,5-di(tert-butyl)-4-hydroxyphenyl) adipate.

Tocopherols, for example α-tocopherol, β-tocopherol, γ-tocopherol, δ-tocopherol and mixtures thereof (vitamin E).

Hydroxylated thiodiphenyl ethers, for example 2,2′-thiobis(6-(tert-butyl)-4-methyl-phenol), 2,2′-thiobis(4-octylphenol), 4,4′-thiobis(6-(tert-butyl)-3-methyl phenol), 4,4′-thio-bis(6-(tert-butyl)-2-methyl phenol), 4,4′-thiobis(3,6-di(sec-amyl)phenol) and 4,4′-bis(2,6-dimethyl-4-hydroxyphenyl) disulfide.

Alkylidenebisphenols, for example 2, 2′-methylenebis(6-(tert-butyl)-4-methylphenol), 2,2′-methylenebis(6-(tert-butyl)-4-ethylphenol), 2,2′-methylenebis[4-methyl-6-α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di(tert-butyl)phenol), 2,2′-ethylidenebis(4,6-di(tert-butyl)phenol), 2,2′-ethylidenebis(6-(tert-butyl)-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di(tert-butyl)phenol), 4,4′-methylenebis(6-(tert-butyl)-2-methylphenol), 1,1-bis(5-(tert-butyl)-4-hydroxy-2-methylphenyl)butane, 2,6-bis(3-(tert-butyl)-5-methyl-2-hydroxybenzyl)-4-methylphenol, 1,1,3-tris(5-(tert-butyl)-4-hydroxy-2-methylphenyl)butane, 1,1-bis(5-(tert-butyl)-4-hydroxy-2-methylphenyl)-3-(n-dodecylmercapto)butane, ethylene glycol bis[3,3-bis(3-(tert-butyl)-4-hydroxyphenyl)butyrate], bis(3-(tert-butyl)-4-hydroxy-5-methylphenyl)dicyclopentadiene, bis[2-(3′-(tert-butyl)-2-hydroxy-5-methylbenzyl)-6-(tert-butyl)-4-methylphenyl]terephthalate, 1,1-bis(3,5-dimethyl-2-hydroxyphenyl)butane, 2,2-bis(3,5-di(tert-butyl)-4-hydroxyphenyl)propane, 2,2-bis(5-(tert-butyl)-4-hydroxy-2-methylphenyl)-4-(n-dodecylmercapto)butane and 1,1,5,5-tetra(5-(tert-butyl)-4-hydroxy-2-methylphenyl)pentane.

Benzyl compounds, for example 3, 5,3′,5′-tetra(tert-butyl)-4,4′-dihydroxydibenzyl ether, octadecyl 4-hydroxy-3,5-dimethylbenzylmercaptoacetate, tridecyl 4-hydroxy-3,5-di(tert-butyl)benzylmercaptoacetate, tris(3,5-di(tert-butyl)-4-hydroxybenzyl)amine, 1,3,5-tri(3,5-di(tert-butyl)-4-hydroxybenzyl)-2,4,6-trimethylbenzene, di(3,5-di(tert-butyl)-4-hydroxybenzyl) sulfide, isooctyl 3,5-di(tert-butyl)-4-hydroxybenzylmercaptoacetate, bis(4-(tert-butyl)-3-hydroxy-2,6-dimethylbenzyl) dithioterephthalate, 1,3,5-tris(3,5-di(tert-butyl)-4-hydroxybenzyl) isocyanurate, 1,3,5-tris(4-(tert-butyl)-3-hydroxy-2,6-dimethylbenzyl) isocyanurate, 3,5-di(tert-butyl)-4-hydroxybenzyl dioctadecyl phosphate and 3,5-di(tert-butyl)-4-hydroxybenzyl monoethyl phosphate, calcium salt.

Hydroxybenzylated malonates, for example dioctadecyl 2,2-bis(3,5-di(tert-butyl)-2-hydroxybenzyl)malonate, dioctadecyl 2-(3-(tert-butyl)-4-hydroxy-5-methyl-benzyl)malonate, didodecylmercaptoethyl 2,2-bis(3,5-di(tert-butyl)-4-hydroxy-benzyl)malonate and bis[4-(1,1,3,3-tetramethylbutyl)phenyl] 2,2-bis(3,5-di(tert-butyl)-4-hydroxybenzyl)malonate.

Hydroxybenzyl aromatic compounds, for example 1, 3,5-tris(3,5-di(tert-butyl)-4-hydroxybenzyl)-2,4,6-trimethylbenzene, 1,4-bis(3,5-di(tert-butyl)-4-hydroxybenzyl)-2,3,5,6-tetramethylbenzene and 2,4,6-tris(3,5-di(tert-butyl)-4-hydroxybenzyl)phenol.

Triazine compounds, for example 2,4-bis(octylmercapto)-6-(3,5-di(tert-butyl)-4-hydroxyanilino)-1,3,5-triazine, 2-octylmercapto-4,6-bis(3,5-di(tert-butyl)-4-hydroxy-anilino)-1,3,5-triazine, 2-octylmercapto-4,6-bis(3,5-di(tert-butyl)-4-hydroxyphenoxy)-1,3,5-triazine, 2,4,6-tris(3,5-di(tert-butyl)-4-hydroxyphenoxy)-1,3,5-triazine, 1,3,5-tris(3,5-di(tert-butyl)-4-hydroxybenzyl) isocyanurate, 1,3,5-tris(4-(tert-butyl)-3-hydroxy-2,6-dimethylbenzyl) isocyanurate, 2,4,6-tris(3,5-di(tert-butyl)-4-hydroxyphenylethyl)-1,3,5-triazine, 1,3,5-tris(3,5-di(tert-butyl)-4-hydroxyphenylpropionyl)hexahydro-1,3,5-triazine and 1,3,5-tris(3,5-dicyclohexyl-4-hydroxybenzyl) isocyanurate.

Benzylphosphonates, for example dimethyl 2,5-di(tert-butyl)-4-hydroxy-benzylphosphonate, diethyl 3,5-di(tert-butyl)-4-hydroxybenzylphosphonate ((3,5-bis(1,1-dimethylethyl)-4-hydroxyphenyl)methylphosphonic acid diethyl ester), dioctadecyl 3,5-di(tert-butyl)-4-hydroxybenzylphosphonate, dioctadecyl 5-(tert-butyl)-4-hydroxy-3-methylbenzylphosphonate and calcium salt of 3,5-di(tert-butyl)-4-hydroxybenzylphosphonic acid monoethyl ester.

Acylaminophenols, for example lauric acid 4-hydroxyanilide, stearic acid 4-hydroxyanilide, 2,4-bisoctylmercapto-6-(3,5-di-tert-butyl-4-hydroxyanilino)-s-triazine and octyl N-(3,5-di(tert-butyl)-4-hydroxyphenyl)carbamate.

Esters of β-(3,5-di(tert-butyl)-4-hydroxyphenyl)propionic acid with mono- or polyhydric alcohols, such as, e.g., with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of β-(5-(tert-butyl)-4-hydroxy-3-methylphenyl)propionic acid with mono- or polyhydric alcohols, such as, e.g., with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of β-(3,5-dicyclohexyl-4-hydroxyphenyl)propionic acid with mono- or polyhydric alcohols, such as, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of 3,5-di(tert-butyl)-4-hydroxyphenylacetic acid with mono- or polyhydric alcohols, such as, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapenta-decanol, trimethylhexanediol, trimethylolpropane and 4-hydroxymethyl-1-phospha-2,6,7-trioxabicyclo[2.2.2]octane.

Amides of β-(3,5-di(tert-butyl)-4-hydroxyphenyl)propionic acid, such as, e.g., N,N′-bis(3,5-di(tert-butyl)-4-hydroxyphenylpropionyl)hexamethylenediamine, N,N′-bis(3,5-di(tert-butyl)-4-hydroxyphenylpropionyl)trimethylenediamine, N,N′-bis(3,5-di(tert-butyl)-4-hydroxyphenylpropionyl)hydrazine and N,N′-bis[2-(3-[3,5-di(tert-butyl)-4-hydroxy-phenyl]propionyloxy)ethyl]oxamide (e.g. Naugard® XL-1 from Uniroyal).

### Ascorbic Acid (Vitamin C)

Aminic antioxidants, such as N,N′-diisopropyl-p-phenylenediamine, N,N′-di(sec-butyl)-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylene-diamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-tolylsulfamoyl)-diphenylamine, N,N′-dimethyl-N,N′-di(sec-butyl)-p-phenylenediamine, diphenylamine, N-allyidiphenylamine, 4-isopropoxydiphenylamine, N-phenyl-1-naphthylamine, N-(4-(tert-octyl)phenyl)-1-naphthylamine, N-phenyl-2-naphthylamine, octylated diphenyl-amine, e.g. p,p′-di(tert-octyl)diphenylamine, 4-(n-butylamino)phenol, 4-butyrylamino-phenol, 4-nonanoylaminophenol, 4-dodecanoylaminophenol, 4-octadecanoylamino-phenol, bis(4-methoxyphenyl)amine, 2,6-di(tert-butyl)-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, mixture of mono- and dialkylated tert-butyl/tert-octyldiphenylamines, mixture of mono- and dialkylated nonyldiphenylamines, mixture of mono- and dialkylated dodecyldiphenylamines, mixture of mono- and dialkylated isopropyl/isohexyldiphenylamines, mixture of mono- and dialkylated tert-butyldiphenyl-amines, 2,3-dihydro-3,3-dimethyl-4H-1,4-benzothiazine, phenothiazine, mixture of mono- and dialkylated tert-butyl/tert-octylphenothiazines, mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethyl-4-piperidyl)sebacate, 2,2,6,6-tetramethylpiperidin-4-one, 2,2,6,6-tetramethylpiperidin-4-ol, the dimethyl succinate polymer with 4-hydroxy-2,2,6,6-tetramethyl-1-piperidinethanol [CAS number 65447-77-0] (for example Tinuvin® 622 from Ciba Specialty Chemicals Inc.) and the polymer of 2,2,4,4-tetramethyl-7-oxa-3,20-diazadispiro[5.1.11.2]heneicosan-21-one and epichlorohydrin [CAS-No.: 202483-55-4] (for example Hostavin® N 30 from Ciba Specialty Chemicals, Inc.).

The group i) of the nickel compounds includes, for example, nickel complexes of 2,2′-thiobis[4-(1,1,3,3-tetramethylbutyl)phenol], such as the 1:1 or 1:2 complex, if appropriate with additional ligands, such as n-butylamine, triethanolamine, or N-cyclohexyldiethanolamine, nickel dibutyldithiocarbamate, nickel salts of monoalkyl 4-hydroxy-3,5-di-tert-butylbenzylphosphonates, e.g. the methyl or ethyl ester, nickel complexes of ketoximes, e.g. of 2-hydroxy-4-methylphenyl undecyl ketoxime, nickel complex of 1-phenyl-4-lauroyl-5-hydroxypyrazole, if appropriate with additional ligands.

The group j) of the sterically hindered amines includes, for example, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) (n-butyl)(3,5-di(tert-butyl)-4-hydroxybenzyl)malonate, condensation product of 1-(2-hydroxyethyl)-2,2,6,6-tetramethyl-4-hydroxypiperidine and succinic acid, condensation product of N,N′-bis(2,2,6,6-tetramethyl-4-piperidyl)hexamethylenediamine and 4-(tert-octylamino)-2,6-dichloro-1,3,5-triazine, tris(2,2,6,6-tetramethyl-4-piperidyl) nitrilotriacetate, tetrakis-(2,2,6,6-tetramethyl-4-piperidyl) 1,2,3,4-butanetetracarboxylate, 1,1′-(1,2-ethylene)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethyl-4-piperidyl) 2-(n-butyl)-2-(2-hydroxy-3,5-di(tert-butyl)benzyl)malonate, 3-(n-octyl)-7,7,9,9-tetramethyl-1,3,8-triazaspiro[4.5]decane-2,4-dione, bis(1-octyloxy-2,2,6,6-tetramethyl-4-piperidyl) sebacate, bis(1-octyloxy-2,2,6,6-tetramethyl-4-piperidyl) succinate, condensation product of 2-chloro-4,6-bis(4-(n-butyl)amino-2,2,6,6-tetramethyl-4-piperidyl)-1,3,5-triazine and 1,2-bis(3-aminopropylamino)ethane, condensation product of 2-chloro-4,6-di(4-(n-butyl)amino-1,2,2,6,6-pentamethyl-4-piperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)-pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, condensation product of N,N′-bis(2,2,6,6-tetramethyl-4-piperidyl)hexamethylene-diamine and 4-cyclohexylamino-2,6-dichloro-1,3,5-triazine, condensation product of 1,2-bis(3-aminopropylamino)ethane and 2,4,6-trichloro-1,3,5-triazine, 4-butylamino-2,2,6,6-tetramethylpiperidine, N-(2,2,6,6-tetramethyl-4-piperidyl)(n-dodecyl)succinimide, N-(1,2,2,6,6-pentamethyl-4-piperidyl)(n-dodecyl)succinimide, 2-undecyl-7,7,9,9-tetramethyl-1-oxa-3,8-diaza-4-oxospiro[4.5]decane, condensation product of 7,7,9,9-tetramethyl-2-cycloundecyl-1-oxa-3,8-diaza-4-oxospiro[4.5]decane and epichlorohydrin, poly[methylpropyl-3-oxo-4-(2,2,6,6-tetramethyl-4-piperidyl)]siloxane polymer-analogous reaction products derived from 4-amino-2,2,6,6,-tetramethylpiperidine and maleic acid/C₂₀-C₂₄-α-olefin copolymers, e.g. Uvinul® 5050H (BASF Aktiengesellschaft, Ludwigshafen), and polymer-analogous reaction products corresponding thereto using 4-amino-1,2,2,6,6-pentamethylpiperidine (e.g. “methylated Uvinul® 5050H”), condensation products of tetramethylol acetylenediurea and 4-amino-2,2,6,6-tetramethylpiperidine, e.g. Uvinul® 4049H (BASF Aktiengesellschaft, Ludwigshafen), and condensation products corresponding thereto using 4-amino-1,2,2,6,6-pentamethylpiperidine (e.g. “methylated Uvinul® 4049H”), poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]] [CAS No. 71878-19-8], 1,3,5-triazine-2,4,6-triamine, 1,5,8,12-tetrakis[4,6-bis(N-butyl-N-1,2,2,6,6-pentamethyl-4-piperidylamino)-1,3,5-triazin-2-yl]-1,5,8,12-tetraazadodecane (CAS No. 106990-43-6) (e.g. Chimassorb 119 from Ciba Specialty Chemicals Inc.).

The group k) of the metal deactivators includes, for example, N,N′-diphenyloxamide, N-salicylal-N′-salicyloylhydrazine, N,N′-bis(salicyloyl)hydrazine, N,N′-bis(3,5-di(tert-butyl)-4-hydroxyphenylpropionyl)hydrazine, 3-salicyloylamino-1,2,4-triazole, the bis(benzylidene) derivative of oxalic dihydrazide, oxanilide, isophthalic dihydrazide, sebacic bisphenylhydrazide, N,N′-diacetyladipic acid dihydrazide, N,N′-bis(salicyloyl)-oxalic acid dihydrazide or N,N′-bis(salicyloyl)thiopropionic dihydrazide.

The group I) of the phosphites and phosphonites includes, for example, triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di(tert-butyl)phenyl) phosphite, diisodecyl pentaerythritol diphosphite, bis(2,4-di(tert-butyl)phenyl) pentaerythritol diphosphite, bis(2,6-di(tert-butyl)-4-methylphenyl) pentaerythritol diphosphite, diisodecyloxy pentaerythritol diphosphite, bis(2,4-di(tert-butyl)-6-methylphenyl) pentaerythritol diphosphite, bis(2,4,6-tris(tert-butyl)phenyl) pentaerythritol diphosphite, tristearyl sorbitol triphosphite, tetrakis(2,4-di(tert-butyl)phenyl) 4,4′-biphenylenediphosphonite, 6-isooctyloxy-2,4,8,10-tetra(tert-butyl)dibenzo[d,f][1,3,2]dioxaphosphepin, 6-fluoro-2,4,8,10-tetra(tert-butyl)-12-methyldibenzo[d,g][1,3,2]dioxaphosphocin, bis(2,4-di(tert-butyl)-6-methylphenyl)methyl phosphite, bis(2,4-di(tert-butyl)-6-methylphenyl)ethyl phosphite, 2,2′,2″-nitrilo[triethyl-tris(3,3′,5,5′-tetra(tert-butyl)-1,1′-biphenyl-2,2′-diyl) phosphite] and 2-ethylhexyl (3,3′,5,5′-tetra(tert-butyl)-1,1′-biphenyl-2,2′-diyl) phosphite.

The group m) of the hydroxylamines includes, for example, N,N-dibenzylhydroxyl-amine, N,N-diethylhydroxylamine, N,N-dioctylhydroxylamine, N,N-dilauryl-hydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N-methyl-N-octadecylhydroxylamine and N,N-dialkylhydroxylamine from hydrogenated tallow fatty amines.

The group n) of the nitrones includes, for example, N-benzyl-α-phenylnitrone, N-ethyl-α-methylnitrone, N-octyl-α-heptylnitrone, N-lauryl-α-undecylnitrone, N-tetradecyl-α-tridecylnitrone, N-hexadecyl-α-pentadecylnitrone, N-octadecyl-α-heptadecylnitrone, N-hexadecyl-α-heptadecylnitrone, N-octadecyl-α-pentadecylnitrone, N-heptadecyl-α-heptadecylnitrone, N-octadecyl-α-hexadecylnitrone, N-methyl-α-heptadecylnitrone and nitrones derived from N,N-dialkylhydroxylamines prepared from hydrogenated tallow fatty amines.

The group o) of the amine oxides includes, for example, amine oxide derivatives as disclosed in U.S. Pat. Nos. 5,844,029 and 5,880,191, didecylmethylamine oxide, tridecylamine oxide, tridodecylamine oxide and trihexadecylamine oxide.

The group p) of the benzofuranones and indolinones includes, for example, those disclosed in U.S. Pat. Nos. 4,325,863, 4,338,244, 5,175,312, 5,216,052 or 5,252,643, in DE-A-4316611, in DE-A-4316622, in DE-A-4316876, in EP-A-0589839 or in EP-A-0591102 or 3-[4-(2-acetoxyethoxy)phenyl]-5,7-di(tert-butyl)benzofuran-2(3H)-one, 5,7-di(tert-butyl)-3-[4-(2-stearoyloxyethoxy)phenyl]benzofuran-2(3H)-one, 3,3′-bis[5,7-di(tert-butyl)-3-(4-[2-hydroxyethoxy]phenyl)benzofuran-2(3H)-one], 5,7-di(tert-butyl)-3-(4-ethoxyphenyl)benzofuran-2(3H)-one, 3-(4-acetoxy-3,5-dimethylphenyl)-5,7-di(tert-butyl)benzofuran-2(3H)-one, 3-(3,5-dimethyl-4-pivaloyloxyphenyl)-5,7-di(tert-butyl)benzofuran-2(3H)-one, 3-(3,4-dimethylphenyl)-5,7-di(tert-butyl)benzofuran-2(3H)-one, Irganox® HP-136 from Ciba Specialty Chemicals and 3-(2,3-dimethylphenyl)-5,7-di(tert-butyl)benzofuran-2(3H)-one.

The group q) of the thiosynergists includes, for example, dilauryl thiodipropionate or distearyl thiodipropionate.

The group r) of the peroxide-destroying compounds includes, for example, esters of β-thiodipropionic acid, e.g. the lauryl, stearyl, myristyl or tridecyl ester, mercaptobenzimidazole or the zinc salt of 2-mercaptobenzimidazole, zinc dibutyl-dithiocarbamate, dioctadecyl disulfide or pentaerythritol tetrakis(β-dodecylmercapto-propionate).

The group s) of the basic costabilizers includes, for example, melamine, polyvinyl-pyrrolidone, dicyandiamide, triallyl cyanurate, urea derivatives, hydrazine derivatives, amines, polyamides, polyurethanes, the alkali metal and alkaline earth metal salts of higher fatty acids, e.g. calcium stearate, zinc stearate, magnesium behenate, magnesium stearate, sodium ricinoleate, and potassium palmitate, antimony pyrocatecholate or zinc pyrocatecholate.

Other light stabilizers that can be used are in particular diphenylcyanoacrylates, such as ethyl 2-cyano-3,3-diphenylacrylate. Another preferred embodiment of the present invention therefore provides a composition in which the compound of the formula (I) is N,N′-bis(formyl)-N,N′-bis(2,2,6,6-tetramethyl-4-piperidyl)-1,6-hexanediamine and the other light stabilizer is ethyl 2-cyano-3,3-diphenylacrylate.

Another antioxidant that can be used is in particular sterically hindered amines. Very particular preference is given to polymer-analogous reaction products derived from 4-amino-2,2,6,6-tetramethylpiperidine and maleic acid/C₂₀-C₂₄-α-olefin copolymers, e.g. Uvinul® 5050H (BASF Aktiengesellschaft, Ludwigshafen) and the polymer-analogous reaction products corresponding thereto using 4-amino-1,2,2,6,6-pentamethylpiperidine (e.g. “methylated Uvinul® 5050H”). Another preferred embodiment of the present invention therefore provides a composition in which the compound of the formula (I) is N,N′-bis(formyl)-N,N′-bis(2,2,6,6-tetramethyl-4-piperidyl)-1,6-hexanediamine and the polymer-analogous reaction products derived from 4-amino-2,2,6,6-tetramethyl-piperidine and maleic acid/C₂₀-C₂₄-α-olefin copolymers, or that corresponding thereto and methylated on the piperidine nitrogen atom is present as other light stabilizer.

The compounds of the groups a) to s) are, with the exception of the benzofuranones of group p), used in conventional amounts, for example in amounts of from 0.0001 to 10% by weight, preferably from 0.01 to 1% by weight, based on the total weight of the composition.

The additives of group t) are used in the conventional amounts. The amount usually used of these is from 0 to 60% by weight, based on the total weight of the composition. According to the invention, the composition can also comprise antistatic agents. Examples of suitable antistatic agents are amine derivatives, such as N,N-bis(hydroxy-alkyl)alkylamines or -alkyleneamines, polyethylene glycol esters and polyethylene glycol ethers, ethoxylated carboxylic esters, ethoxylated carboxamides, and glycerol mono- and distearates, and their mixtures.

Suitable fillers or reinforcing materials comprise, for example, the abovementioned pigments, such as carbon black, graphite, calcium carbonate, silicates, talc, mica, kaolin, barium sulfate, metal oxides, metal hydroxides, wood flour and flours or fibers derived from other natural products, and synthetic fibers. Other examples of fibrous or pulverulent fillers that can be used are carbon fibers or glass fibers in the form of short glass fibers, long glass fibers, ground glass fibers, glass textiles, glass mats or glass silk rovings, chopped glass strands, glass beads and wollastonite.

The inventive composition can moreover comprise nucleating agents. Among the suitable nucleating agents are, for example, inorganic substances, such as talc, metal oxides, e.g. titanium dioxide or magnesium oxide, phosphates, carbonates, or sulfates, preferably of alkaline earth metals; organic compounds, such as mono- or poly-carboxylic acids and their salts, e.g. 4-tert-butylbenzoic acid, adipic acid, diphenylacetic acid, sodium succinate, or sodium benzoate; polymeric compounds, such as ionic copolymers (“ionomers”).

The present invention also provides a printing-ink composition comprising at least one printing ink and at least one inventive nanoparticulate preparation.

Printing inks are solid, paste-like, or liquid colorant preparations used in printing machines. The suitability of printing inks is dependent on the respective printing processes in which they are used, and on the material to be printed.

The material to be printed can be absorbent or non-absorbent and its dimensions can be mono-dimensional, e.g. fibrous, two-dimensional (planar), or three-dimensional, e.g. cylindrical or conical. Examples of planar materials are paper, paper board, leather, or foils, e.g. plastics foils or metal foils. Examples of cylindrical or conical materials are hollow bodies, such as containers. Preferred materials are paper and plastics foils. Suitable plastics are the polymers mentioned under the inventive polymer composition.

The inventive printing-ink composition can be used in any of the familiar printing processes, e.g. relief printing, such as letterpress printing and flexographic printing, planographic printing, such as offset printing, lithographic printing, and photographic printing, intaglio printing, such as rotogravure printing, and die-stamp printing, and also permeative printing processes, such as screen printing, and printing processes involving frame methods, film methods, and template methods. It is preferable that the inventive printing-ink composition is used in offset printing.

Suitable colorants are either pigments or dyes. Suitable pigments and dyes are any of the colorants conventional in the respective printing process.

The inventive printing-ink composition generally comprises a colorant composition conventional for the respective printing process and an inventive nanoparticulate preparation.

Conventional colorant compositions generally comprise, alongside the colorant, binders, which are mostly termed print varnishes, and additives, such as driers, diluents, wax dispersions and, if appropriate, catalysts or initiators for radiation-drying. The detail of the composition is selected as a function of the printing process, the substrate to be printed, and the desired quality to be obtained in the printing process, in relation to appearance, e.g. gloss, opacity, color shade, and transparency, and to physical properties, such as water-resistance, oil-resistance, solvent-resistance, wear-resistance, and laminatability.

Suitable varnishes for paste-like inks for use in offset printing, in letterpress printing, and in screen printing are therefore composed by way of example of stand oils, phenol-modified rosins, mineral oils, linseed oil, and/or alkyd resins (combination varnishes), or of hydrocarbon resins and of rosins, asphalt, and cyclorubber (mineral-oil varnishes). Examples of suitable varnishes for flexographic, intaglio, and screen-printing inks are resin-solvent systems with nitrocellulose with polyamide resins, with ketone resins, with vinyl polymers, with maleate resins, with phenolic resins, with amine resins, with acrylic resins, with polyester resins, or with polyurethane resins, as binder, and with a solvent, such as ethanol, or ethyl acetate, or high-boiling-point alcohols, esters, and glycol ethers.

An example of the method of modification of the colorant composition with the nanoparticulate preparation is intimate mixing of said components. As an alternative, it is also possible that all of the individual components of the colorant composition are mixed together with polyisobutenephosphonic acid to give the inventive printing-ink composition. However, it is also possible that individual components of the colorant composition are first mixed with polyisobutenephosphonic acid and that this mixture is then mixed with the remaining components.

The invention further provides the use of a nanoparticulate preparation, as defined above, as additive for a polymer composition or a printing-ink composition.

The present invention also provides a process for identification-marking a plastics part, as described above. By way of example, the method of the laser inscription is such that the test specimen is placed in the beam path of a laser, preferably of a pulsed laser. It is preferable to use an Nd-YAG laser. Inscription using an excimer laser is also possible, e.g. by way of a mask technique. However, the desired results can also be achieved using other conventional types of lasers whose wavelength is in a region of high absorption of the pigment used, e.g. CO₂ lasers. The resultant marking is determined via the irradiation time (or pulse count in the case of pulse lasers) and via the irradiation power of the laser and the irradiation performance of the plastics system used. The power of the lasers used depends on the particular application and can readily be determined by the person skilled in the art for a particular case.

The inventive pigmented plastic can be used in any of the sectors which have hitherto used conventional printing processes for inscription of plastics. By way of example, moldings composed of the inventive plastic can be used in the electrical, electronics, or motor vehicle industry. For identification-marking and inscription of, for example, cables, lines, decorative strips, or functional parts in the heating, ventilation, or cooling sector, or switches, plugs, levers, and grips which are composed of the inventive plastic, they can be marked with the aid of laser light even at sites to which access is difficult. Moreover, because the inventive plastics system has very low heavy-metal content it can be used in packaging in the food sector or in the toy sector. A feature of the markings on the packaging is that they are wipe- and scratch-resistant, resistant to subsequent sterilization processes, and capable of application under hygienically clean conditions during the marking process. Complete label images can be applied durably to packaging for a multi-use system. Another important application sector for laser inscription is plastics tags for the individual identification-marking of animals, known as cattle tags or ear tags. The information specifically relevant to the animal is stored by way of a barcode system. It can be called up again when required with the aid of a scanner. The inscription has to be highly durable, since some of the tags remain on the animals for some years.

The following, non-limiting examples provide further illustration of the invention.

### EXAMPLES

Commercially available lanthanum hexaboride (H. C. Starck, Goslar) was fully dispersed at 20.4% strength (1 kg of LaB₆ and 3.9 kg of carrier medium composed of THF and stearyl stearate) for 14 h in a Drais mill, by means of 3 mm ZrO₂ grinding beads. The suspension was then spray-dried. The resultant primary particle size was about 80 nm. The nanoparticulate (Inventive Example 1, 2) or non-nanoparticulate (Comparative Example 1, 2) lanthanum hexaboride, nylon-6 (standard polyamide (Ultramid B3UG4 LS gray, BASF Aktiengesellschaft)), glass fibers, and melamine cyanurate were extruded in a twin-screw extruder to give a polyamide mixture, and then further processed in an injection-molding machine.

| | | |
|---|---|---|
| Comparative | 69.985% | of nylon-6 |
| Example 1: | 20% | of glass fibers |
| | 10% | of melamine cyanurate |
| | 0.005% | of lanthanum hexaboride (microdisperse) |
| Comparative | 69.985% | of nylon-6 |
| Example 2: | 20% | of glass fibers |
| | 10% | of melamine cyanurate |
| | 0.015% | of lanthanum hexaboride (microdisperse) |

| | |
|---|---|
| Comparative | Specific grades for laser inscription, without lanthanum |
| Example 3: | hexaboride |

Nylon-6

| | | |
|---|---|---|
| Inventive | 69.985% | of nylon-6 |
| Example 1: | 20% | of glass fibers |
| | 10% | of melamine cyanurate |
| | 0.005% | of lanthanum hexaboride (nanodisperse, fully |
| | | dispersed in THF, and stearyl stearate was |
| | | also added during the milling process) |
| Inventive | 69.985% | of nylon-6 |
| Example 2: | 20% | of glass fibers |
| | 10% | of melamine cyanurate |
| | 0.015% | of lanthanum hexaboride (nanodisperse, fully |
| | | dispersed in THF, and stearyl stearate was |
| | | also added during the milling process) |

The vector process was used for laser inscription, and in this a laser beam was deflected via two computer-controlled rotating mirrors moved by galvanometers in such a way that the desired script was produced in the plane of inscription (=focal plane of the focusing lens). The laser source used comprised a 50 W multimode Nd: YAG solid-state laser whose wavelength was 1064 nm. The beam diameter at the focus was 100 μm. Contrast was determined visually, the assessment ranging from 1 (very good) to 6 (very poor).

Table 1 shows the results:

Laser inscribability was measured visually, and CTI (comparative
tracking index) was determined to IEC112, elongation at break
(in %) was determined to ISO 527-2, and Charpy impact resistance
at 23° C. (in kJ/m²) was determined to ISO 179/1eU.

| | Inv. | Inv. | Comp. | Comp. | Comp. |
|---|---|---|---|---|---|
| | Ex. 1 | Ex. 2 | Ex. 1 | Ex. 2 | Ex. 3 |
| Laser inscribability | 3 | 2 | 5 | 4-5 | 4 |
| CTI | 425 | 425 | 425 | 425 | 350 |
| Elongation at break [%] | 3.3 | 3.2 | 3.3 | 3.2 | 2.6 |
| Charpy impact resistance | 43 | 42 | 42 | 41 | 38 |
| (+23° C.) [kJ/m²] | | | | | |

CTI = comparative tracking index, test solution A.

The inventive nylon-6 using nanoparticulate lanthanum hexaboride additive has better contrast of the inscription, with a markedly lower proportion of additive, and with this has advantages in mechanical properties and CTI.

General production specification for modifying plastics parts composed of thermoplastic polytetrahydrofuran polyurethane (TPU):

In a first variant of the process, the laser-contrast agent LaB₆ is milled in polytetrahydrofuran (Mₙ 1000) to give nanoparticles, giving a 10% strength by weight fully dispersed suspension. This 10% strength suspension is diluted with pure polytetrahydrofuran (Mₙ 1000) sufficiently to permit production of test specimens with from 10 to 1000 ppm of LaB₆, based on the total weight of TPU. Very good dispersion of the contrast agent in the polyurethane matrix is important for sharp laser inscription. This is achieved via dispersion of the LaB₆ in the liquid precursor of the TPU via a full-dispersion process. The incorporation of a dry LaB₆ nanopowder into a (TPU) polymer melt, carried out as comparative example, led to relatively poor dispersion and moreover to dust contamination during the incorporation process. The second incorporation method is the production of a concentrate (e.g. of a 2% strength concentrate) by the method stated above (milling of LaB₆ in polytetrahydrofuran and production of a TPU from said polytetrahydrofuran) and addition of an appropriate amount of the concentrate to a standard TPU directly prior to processing to give injection-molded sheets or extrusion products. An advantage of this method is that the concentration of the LaB₆ in the polymer matrix can be varied more easily. Since the nanopowder has good dispersion in the concentrate, which is still relatively dilute, dispersion in the final product is also good. In one specific embodiment (see formulation example TPU4), the carrier medium with the fully dispersed LaB₆ nano-particles is used as starting material for production of the polyether polyurethanes.

### Formulation Example TPU1

Injection moldings were produced from a thermoplastic polyether polyurethane of Shore hardness 85 A based on 1000 parts of polytetrahydrofuran with average molecular weight of 1000, 600 parts of MDI, and 126 parts of 1,4-butanediol, and these comprised 100 ppm of LaB₆, which had previously been milled in polytetrahydrofuran (Mₙ 1000) to give nanoparticles.

### Formulation Example TPU2

Injection moldings were produced from a thermoplastic polyether polyurethane of Shore hardness 85 A based on 1000 parts of polytetrahydrofuran with average molecular weight of 1000, 600 parts of MDI, and 126 parts of 1,4-butanediol, and these comprised 1000 ppm of LaB₆, which had previously been milled in polytetrahydrofuran (Mₙ 1000) to give nanoparticles.

### Formulation Example TPU Concentrate3

A 2% strength LaB₆ concentrate in a thermoplastic polyether polyurethane of Shore hardness 85 A based on 1000 parts of polytetrahydrofuran with average molecular weight of 1000, 600 parts of MDI, and 126 parts of 1,4-butanediol was produced by milling the required LaB₆ in polytetrahydrofuran (Mₙ 1000) to give nanoparticles, prior to the reaction. The resultant black product was pelletized and used as laser-inscription concentrate.

### Formulation Example TPU4

Injection moldings were produced from a thermoplastic polyurethane of Shore hardness 90 A. To produce the thermoplastic polytetrahydrofuran polyurethane, 1000 parts of butyl hexyl adipate with molecular weight of 2000, 580 parts of MDI, 162 parts of 1,4-butanediol, and 90 parts of TPU concentrate3 were subjected to a polyaddition reaction.

The TPU1 injection-molded sheets were transparent, and the TPU2 and TPU4 injection-molded sheets were dark green/black and semitransparent.

TPU1 exhibited a dark inscription on a transparent background after inscription with a Nd:YAG laser at 1064 nm, and the inscription here was “within” the test sheet and there were no surface defects. TPU2 and TPU4 exhibited a very fine white inscription on a dark background after exposure to the laser.

1. A fully dispersed, nanoparticulate preparation, comprising a carrier medium which is liquid under standard conditions and at least one particulate phase of nanoscale particles dispersed therein, said particulate phase comprising at least one metal boride of the general formula MB6, in which M is a metal component.

2. The preparation according to claim 1, for whose production at least one metal boride MB₆ is comminuted in the carrier medium.

3. The preparation according to claim 2, where the comminution takes place via milling.

4. The preparation according to claim 2, where at least one metal boride MB₆ is used in non-nanoparticulate form for the comminution process.

5. The preparation according to claim 1, where the volume-average particle diameter of the resultant nanoscale particles is at most 200 nm.

6. The preparation according to claim 1, where the solids content, based on the total weight of the preparation, is at least 10% by weight.

7. The preparation according to claim 1, where the content of metal boride MB₆, based on the total solids content of the preparation, is at least 10% by weight.

8. The preparation according to claim 1, where the metal boride MB₆ is selected from alkaline earth metal borides, rare earth metal borides, and mixtures thereof.

9. The preparation according to claim 1, where the carrier medium is selected from esters of alkyl and aryl carboxylic acids, hydrogenated esters of aryl carboxylic acids with alkanols, polyhydric alcohols, ether alcohols, polyether polyols, ethers, saturated acyclic and cyclic hydrocarbons, mineral oils, mineral oil derivatives, silicone oils, aprotic polar solvents, and mixtures thereof.

10. The preparation as claimed in claim 1, which comprises a carrier medium which is suitable as a component for the production of a polymer.

11. The preparation according to claim 10, which comprises a carrier medium which is used for the production of a polymer selected from polyethers, polyesters, polycarbonates, polyurethanes, and mixtures thereof.

12. The preparation according to claim 10, which comprises a carrier medium which is suitable as component for the production of a polyether polyurethane.

13. The preparation according to claim 10, which comprises a carrier medium selected from ethylene glycol, glycerol, 1,3-propanediol, 1,4-butanediol, ethylene glycol monomethyl ether, ethylene glycol dimethyl ether, ethylene glycol diethyl ether, acyclic and cyclic ethers, polyether polyols and mixtures thereof.

14. The preparation according to claim 13, which comprises a polytetrahydrofuran as carrier medium.

15. The nanoparticulate preparation, as defined in claim 1, for use in a polymer composition or in a printing-ink composition, where the boiling point and/or the flashpoint of the nanoparticulate preparation is above the processing temperature used for the production of the polymer composition or of the printing-ink composition.

16. A polymer composition, comprising at least one nanoparticulate preparation as defined in claim 1.

17. A polymer composition, obtainable via polymerization of a reaction mixture comprising a fully dispersed nanoparticulate preparation which comprises a liquid carrier medium as defined in claim 10.

18. The composition according to claim 16, comprising at least one polymer selected from polyolefins, polyolefin copolymers, polytetrafluoroethylenes, ethylene-tetrafluoroethylene copolymers, polyvinyl chlorides, polyvinylidene chlorides, polyvinyl alcohols, polyvinyl esters, polyvinyl alkanals, polyvinyl ketals, polyamides, polyimides, polycarbonates, polycarbonate blends, polyesters, polyester blends, poly(meth)acrylates, poly(meth)acrylate/styrene copolymer blends, poly(meth)acrylate/polyvinylidene difluoride blends, polyurethanes, polystyrenes, styrene copolymers, polyethers, polyether ketones, polysulfones, and mixtures thereof.

19. The composition according to claim 16, which comprises a thermoplastic polymer component.

20. The composition according to claim 16, which comprises at least one polyether polyurethane.

21. The composition according to claim 20, where the polyether polyurethane comprises at least one incorporated polytetrahydrofuran.

22. The fully dispersed, nanoparticulate preparation according to claim 1, which also comprises at least one additive selected from colorants, antioxidants, light stabilizers, metal deactivators, antistatic agents, reinforcing materials, fillers, antifogging agents, biocides, and antistatic agents.

23. A printing-ink composition, comprising at least one nanoparticulate preparation as defined in claim 1.

24. A method of using a nanoparticulate preparation as defined in claim 1 as an additive for a polymer composition or a printing-ink composition.

25. A method of using a nanoparticulate preparation as defined in claim 10 for the production of a polymer.

26. A process for the modification of a plastics part with at least one metal boride, by
providing a fully dispersed, nanoparticulate preparation of dispersed nanoscale particles of at least one metal boride of the general formula MB6, in which M is a metal component, in a carrier medium which is liquid under standard conditions, by comminuting the metal boride in the carrier medium, and
incorporating the fully dispersed, nanoparticulate preparation into the plastics part or applying it to the plastics part, or using it for the production of the plastic for the plastics part.

27. The process according to claim 26, in which the fully dispersed, nanoparticulate preparation is incorporated into the plastics part by way of extrusion, injection-molding, blow-molding, or a kneading process.

28. The process according to claim 26, in which the metal boride is applied by way of a lamination or coating process to the plastics part.

29. A process for the identification-marking of a plastics part, in which
a plastics part is provided which has, at least in the region to be identification-marked, at least one nanoparticulate metal boride of the general formula MB6 which absorbs laser radiation, where M is a metal component, and
the plastics part is irradiated with laser radiation for the identification-marking process.

30. The process according to claim 29, in which, for provision of the plastics part, the metal boride is incorporated into the plastics part or is applied to the plastics part.

31. The process according to claim 30, in which the metal boride is incorporated into the plastics part by way of extrusion, injection-molding, blow-molding, or a kneading process.

32. The process according to claim 30, in which the metal boride is applied by way of a lamination or coating process to the plastics part.

33. The process according to claim 29, in which, for incorporation of the metal boride into the plastics part or for application of the metal boride to the plastics part, a fully dispersed, nanoparticulate preparation is used comprising a carrier medium which is liquid under standard conditions and at least one particulate phase of nanoscale particles dispersed therein, said particulate phase comprising at least one metal boride of the general formula MB₆, in which M is a metal component.

34. The process according to claim 29, in which laser radiation whose wavelength is in the range from 700 to 12000 nm is used for the identification-marking process.

35. A plastics part with identification marking, obtainable via a process as defined in claim 29.

36. A composition suitable for the production of plastics parts capable of identification-marking with the aid of laser radiation whose wavelength is outside the visible region, comprising
a) a thermoplastic matrix polymer suitable for forming the structure of the plastics parts,
b) at least one metal boride MB6, where M has been selected from lanthanoids and alkaline earth metals,
c) optionally, at least one UV stabilizer, and
d) optionally, further additives.
